(19) United States
(12) Patent Application Publication
(10) Pub. No.: US 2026/0367213 A1
(43) Pub. Date: Nov. 19, 2026

(54) METHODS AND APPARATUS FOR SUPPORTING NETWORK VERIFIED UE LOCATION IN A NON-TERRESTRIAL NETWORK

(71) Applicant: Telefonaktiebolaget LM Ericsson (publ), Stockholm (SE)

(72) Inventors: Talha KHAN, SANTA CLARA, CA (US); Johan RUNE, Stockholm (SE); Zhilan XIONG, Stockholm (SE); Stefan ERIKSSON LÖWENMARK, Stockholm (SE); Sebastian EULER, Stockholm (SE); Olof LIBERG, Stockholm (SE)

(73) Assignee: Telefonaktiebolaget LM Ericsson (publ), Stockholm (SE)

(21) Appl. No.: 19/157,155

(22) PCT Filed: Feb. 16, 2024
(86) PCT No.: PCT/EP2024/054083

§ 371 Date: Aug. 15, 2025

Related U.S. Application Data
(60) Provisional application No. 63/485,732, filed on Feb. 17, 2023.

(51) Int. Cl. G01S 5/02; H04B 7/185; H04W 56/00

(52) U.S. Cl. CPC G01S 5/0244; H04B 7/18513; H04W 56/0045

(57) ABSTRACT

A method (1600) performed by a user equipment (UE) for supporting a network verified UE location in a non-terrestrial network (NTN). The method includes measuring (s1602) a UE receive (RX)-transmit (TX) time difference. The method includes transmitting (s1604) to a network node the UE RX-TX time difference measurement, a fractional part F of the measurement and an integer part I of the measurement. The UE RX-TX time difference is equal to the fractional part F plus the integer part I. The method includes receiving (s1606) positioning information for network verified UE location.

### TECHNICAL FIELD

Disclosed are embodiments related to supporting network verified user equipment (UE) location in a non-terrestrial network.

### BACKGROUND

There currently exist certain challenge(s). In 3GPP, 5G system (5GS) is a new generation's radio access technology intended to serve use cases such as enhanced mobile broadband (eMBB), ultra-reliable and low latency communication (URLLC), NB-IOT and mMTC. 5G includes the New Radio (NR) access stratum interface and the 5G Core Network (5GC). The NR physical and higher layers are reusing parts of the LTE specification, and to that add needed components when motivated by new use cases. To benefit from the strong mobile ecosystem and economy of scale, the satellite network based on the terrestrial wireless access technologies including LTE and NR for satellite networks, is being specified in the 3GPP standard.

### NTN Characteristics

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A satellite which does not operate in geostationary earth orbit is also broadly called as NGSO (Non-Geostationary Orbit) satellite. Examples of NGSO satellites are LEO and MEO satellites.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the UE
Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called as non-terrestrial network (NTN). On the other hand mobile network with base stations on the group may also be called as terrestrial network (TN) or non-NTN network. A satellite within NTN may be called as NTN node, NTN satellite or simply a satellite.

FIG. 1 shows an example architecture 100 of a satellite network with bent pipe transponders (i.e. the transparent payload architecture). The gNB 110 may be integrated in the gateway or connected to the gateway via a terrestrial connection (wire, optic fiber, wireless link)

A communication satellite 120 typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam 130. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits is required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

A 3GPP device in RRC_IDLE or RRC_INACTIVE state is required to perform number of procedures including measurements for mobility purposes, paging monitoring, logging measurement results, tracking area update, and search for a new PLMN to mention a few. These procedures will consume power in devices, and a general trend in 3GPP has been to allow for relaxation of these procedures to prolong device battery life. This trend has been especially pronounced for IoT devices supported by reduced capability (redcap), NB IoT and LTE M.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between a UE 140 and satellite 120 can vary significantly, depending on the position of the satellite and thus the elevation angle ε seen by the UE 140. Assuming circular orbits, the minimum distance is realized when the satellite is directly above the UE (ε=90°), and the maximum distance when the satellite is at the smallest possible elevation angle. Table 1 shows the distances between satellite 120 and UE 140 for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles

| | | Distance | | One-way | | Propagation | |
|---|---|---|---|---|---|---|---|
| | Elevation | UE <-> | | propagation | | delay | |
| Orbital height | angle | satellite | | delay | | difference | |
| 600 km | 90° | 600 | km | 2.0 | ms | — | |
| [0001] | 30° | 1075 | km | 3.6 | ms | 1.6 | ms |
| [0001] | 10° | 1932 | km | 6.4 | ms | 4.4 | ms |
| 1200 km | 90° | 1200 | km | 4.0 | ms | — | |
| [0001] | 30° | 1999 | km | 6.7 | ms | 2.7 | ms |
| [0001] | 10° | 3131 | km | 10.4 | ms | 6.4 | ms |
| 35786 km | 90° | 35786 | km | 119.4 | ms | — | |
| [0001] | 30° | 38609 | km | 128.8 | ms | 9.4 | ms |
| [0001] | 10° | 40581 | km | 135.4 | ms | 16.0 | ms |

The propagation delay may also be highly variable due to the high velocity of the LEO and MEO satellites and change in the order of 10-100 μs every second, depending on the orbit altitude and satellite velocity.

### Ephemeris Data

In TR 38.821, it has been captured that ephemeris data should be provided to the UE, for example to assist with pointing a directional antenna (or an antenna beam) towards the satellite. A UE knowing its own position, e.g. thanks to GNSS support, may also use the ephemeris data to calculate correct timing related and/or frequency drifts e.g. Timing Advance (TA) and Doppler shift. The contents of the ephemeris data and the procedures on how to provide and update such data have not yet been studied in detail.

A satellite orbit 210 can be fully described using 6 parameters. The set of these parameters and orbital elements are illustrated in FIG. 2. Exactly which set of parameters is used can be decided by the user; many different representations are possible. For example, a choice of parameters used often in astronomy is the set (a, ε, i, Ω, ω, t). Here, the semi-major axis a 220 and the eccentricity ε 230 describe the shape and size of the orbit ellipse; the inclination i 240, the right ascension of the ascending node Ω 250, and the argument of periapsis ω 260 determine its position in space, and the epoch t determines a reference time (e.g. the time when the satellites moves through periapsis).

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vx, vy, vz) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

### Network Verification of UE Location in NTN

In NR Rel-18 WI on NTN enhancement, the objective on network verified UE location is defined as follows.
Based on RAN1 conclusions of the study phase, RAN to prioritize the specification of necessary enhancements to multi-RTT to support the network verified UE location in NTN assuming a single satellite in view [RAN1, 2, 3, 4].
DL-TDoA methods for verification may be considered as lower priority and if time permits and condition in Note is satisfied.
Note 1: Enhancements assume reuse of the RAT dependent positioning framework
Note 2: The specification of DL-TDoA enhancements will be subject to the study of the impact of realistic UE clock drift onto DL-TDoA performance
Note 3: The target accuracy for position verification purposes is as documented in clause «recommendations» of the 3GPP TR 38.882 (i.e. 10 km granularity)
Note 4: Multiple satellite in view by the UE may be considered if time allows
Note 5: The enhancements may be subject to relevant SA WGs (e.g. SA3/SA3-LI) feedbacks on the reliability of UE reports involved
Note 6: The enhancements should take into account the mirror-image ambiguity
Note 7: Network verified UE location is an optional UE feature

In the RAN2 #120, RAN2 has agreed that
1. RAN2 agrees the re-use of the LCS framework of the LMF for the network verification of UE reported location information in NTN.
2. RAN2 will work on the details of radio protocol aspects of the verification procedure based on the solution investigated by RAN1
From the above agreements, it is observed that the NTN network will rely on the RAT dependent positioning methods to perform the verification for UE.
RAN1 has made the following agreement regarding multi-RTT in RAN1 #111: For network verification of UE location in NR NTN based on multi-RTT using UE RX-TX time difference report, if the UE reports needed to perform multi-RTT can be assumed to be trusted, existing multi-RTT framework may be reused with potential enhancements to adapt it to NTN context. This may include, but not limited to:
   If justified: NTN-specific definition of UE RX-TX time difference, including as an example, potential modifications to UE Rx-Tx time difference to enable network verification of UE location without introducing any additional measurements at the UE (with respect to Rel-17 NTN)
      The following is not precluded: the UE Rx-Tx time difference is defined as T_{UE-RX}−T_{UE-TX}, where T_{UE-RX}−T_{UE-TX} is directly derived from the timing advance TTA applied by the UE at a given subframe.
      Above does not imply that the relevant work is prioritized.
   Other assistance data (e.g. ephemeris) to be transferred from gNB to the LMF.
   If justified: Other assistance data (e.g. to resolve ambiguity on mirror position issue) to be transferred from UE to LMF.
   If justified: Adaptations enabling Rx-TX measurements for Multi-RTT involving multiple cells within the same satellite

### Positioning in 3GPP

In this section, we share some background on positioning in 3GPP. The LTE positioning protocol (LPP) is defined in TS 37.355, NR positioning protocol annex (NRPPa) in TS 38.455, NR physical layer measurements in TS 38.215, and reporting ranges for measured Rx-Tx time differences are specified in TS 38.133.

### Reference Signals

A new Downlink (DL) reference signal, the NR DL PRS (Positioning Reference Signal) was specified in NR Rel-16. The main benefit of this signal in relation to the LTE DL PRS is the increased bandwidth, configurable from 24 to 272 resource blocks (RBs), which gives a big improvement in time of arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel-16.
A new UL reference signal, based on the NR UL Sounding Reference Signal (SRS) was introduced in Rel-16 and called “SRS for positioning”. The Rel. 16 NR SRS for positioning allows for a longer signal, up to 12 symbols (compared to 4 symbols in Rel. 15 SRS), and a flexible position in the slot (only last six symbols of the slot can be used in Rel. 15 SRS). It also allows for a staggered comb resource element (RE) pattern for improved TOA measurement range and for more orthogonal signals based on comb offsets (comb 2, 4 and 8) and cyclic shifts. Power control based on neighbor cell Synchronization Signal Block (SSB)/DL PRS is supported as well as spatial Quasi-CoLocation (QCL) relations towards a Channel State Information Reference Signal (CSI-RS), an SSB, a DL PRS, or another Sounding Reference Signal (SRS).

### Positioning Techniques

NR positioning supports the following methods:
Methods already in LTE and enhanced in NR:
   DL TDOA (Downlink TDOA)
   E-CID
   RAT independent methods (based on non-3GPP sensors such as GPS, pressure sensors, Wifi signals, Bluetooth, etc).
   UL TDOA (Uplink TDOA)
Methods newly introduced methods in NR:
   Multicell RTT: the LMF collects RTT (round trip time) measurement as the basis for multilateration.
   DL angle of departure (AoD) and UL angle of arrival (AoA), where multilateration is done using angle and power (RSRP) measurements

### Measurements:

There are many UE physical layer measurements specified for positioning such as:
DL Reference Signal Time Difference (RSTD), allowing for e.g. DL TDOA positioning
Multi cell UE Rx-Tx Time Difference measurement, allowing for multi cell round trip time (RTT) measurements
DL PRS Reference Signal Receive Power (RSRP)

Similarly, the gNb physical layer measurements are also supported:
Uplink Relative Time of Arrival (UL-RTOA), useful for UL TDOA positioning
gNb Rx-Tx time difference, useful for multi cell RTT measurements
UL SRS-RSRP
Angle of Arrival (AoA) and Zenith angle of Arrival (ZoA)

### UE/gNB Rx-Tx Time Difference Measurements

In 3GPP NR specification, the UE Rx-Tx time different measurement for NR is defined as follows (3GPP TS 38.215 V17.2.0):

| | |
|---|---|
| Definition | The UE Rx − Tx time difference is defined as TUE-RX − TUE-TX |
| | Where: |
| | TUE-RX is the UE received timing of downlink subframe #i from a Transmission |
| | Point (TP) [18], defined by the first detected path in time. |
| | TUE-TX is the UE transmit timing of uplink subframe #j that is closest in time |
| | to the subframe #i received from the TP. |
| | Multiple DL PRS or CSI-RS for tracking resources, as instructed by higher layers, |
| | can be used to determine the start of one subframe of the first arrival path of the |
| | TP. |
| | For frequency range 1, the reference point for TUE-RX measurement shall be the |
| | Rx antenna connector of the UE and the reference point for TUE-TX |
| | measurement shall be the Tx antenna connector of the UE. For frequency range |
| | 2, the reference point for TUE-RX measurement shall be the Rx antenna of the |
| | UE and the reference point for TUE-TX measurement shall be the Tx antenna of |
| | the UE. |
| Applicable for | RRC_CONNECTED, |
| | RRC_INACTIVE |

Note that the transmit time in the measurement definition is the UE transmit timing of the uplink subframe #j that is closest in time to the downlink subframe #i, and not necessarily the transmit timing of the UL SRS.

In 3GPP NR specification, the gNB Rx-Tx time different measurement is defined as follows (3GPP TS 38.215 V17.2.0):

| | |
|---|---|
| Definition | The gNB Rx − Tx time difference is defined as T_{gNB-RX} − T_{gNB-TX} |
| | Where: |
| | T_{gNB-RX} is the Transmission and Reception Point (TRP) [18] received timing of uplink |
| | subframe #i containing SRS associated with UE, defined by the first detected path in |
| | time. |
| | T_{gNB-TX} is the TRP transmit timing of downlink subframe #j that is closest in time to the |
| | subframe #i received from the UE. |
| | Multiple SRS resources can be used to determine the start of one subframe containing |
| | SRS. |
| | The reference point for T_{gNB-RX} shall be: |
| | for type 1-C base station TS 38.104 [9]: the Rx antenna connector, |
| | for type 1-O or 2-O base station TS 38.104 [9]: the Rx antenna (i.e. the centre location of |
| | the radiating region of the Rx antenna), |
| | for type 1-H base station TS 38.104 [9]: the Rx Transceiver Array Boundary connector. |
| | The reference point for T_{gNB-TX} shall be: |
| | for type 1-C base station TS 38.104 [9]: the Tx antenna connector, |
| | for type 1-O or 2-O base station TS 38.104 [9]: the Tx antenna (i.e. the centre location of |
| | the radiating region of the Tx antenna), |
| | for type 1-H base station TS 38.104 [9]: the Tx Transceiver Array Boundary connector. |

An RTT estimate can be calculated as the ‘gNB RX-TX time difference’ minus the ‘UE RX-TX time difference’ by the LMF (note that the ‘gNB RX-TX time difference’ and the ‘UE RX-TX time difference’ measurements are reported to the LMF by the gNB and the UE, respectively). The measurements 300 give the subframe timing difference between UL 310 and DL 320 frames at the gNB 330 and the UE 340 respectively as illustrated in FIG. 3. Illustration of an RTT estimate calculated as the ‘gNB RX-TX time difference’ 350 minus the ‘UE RX-TX time difference’ 360. The measurements give the subframe timing difference between UL 310 and DL 320 frames at the gNB 330 and the UE 340, respectively. The UE Rx frame timing is estimated using a reference signal such as the DL PRS 370. The gNB Rx frame timing is estimated using a reference signal such as the UL SRS 380. In FIG. 3, the Rx-Tx time differences and propagation times have been made much larger than in reality for pedagogic reasons.

### Multi-RTT Positioning

The following excerpts from TS 38.305 (V 17.3.0) are related to the Rel-17 NR multi-RTT positioning specification:

### 8.10.1 General

In the Multi-RTT positioning method, the UE position is estimated based on measurements performed at both, UE and TRPs. The measurements performed at the UE and TRPs are UE/gNB Rx-Tx time difference measurements (and optionally DL-PRS-RSRP, DL-PRS-RSRPP, UL-SRS-RSRP, and/or UL-SRS-RSRPP) of DL-PRS and UL-SRS, which are used by an LMF to determine the RTTs.

The UE may require measurement gaps to perform the Multi-RTT measurements from NR TRPs. The UE may request measurement gaps from a gNB using the procedure described in clause 7.4.1.1. The UE may also request to activate pre-configured measurement gaps as described in clause 7.7.2.

### Information to be Transferred Between NG-RAN/5GC Elements

TABLE 8.10.2.1-1
Assistance data that may be transferred from LMF to the UE
Information

Physical cell IDs (PCIs), global cell IDs (GCIs), and PRS IDs,
ARFCNs of candidate NR TRPs for measurement
Timing relative to the serving (reference) TRP of candidate NR
TRPs
DL-PRS configuration of candidate NR TRPs
SSB information of the TRPs (the time/frequency occupancy of
SSBs)
PRS-only TP indication
On-Demand DL-PRS-Configurations
Validity Area of the Assistance Data

TABLE 8.10.2.2-1
Measurement results that may be transferred from UE to the LMF
Information

PCI, GCI, and PRS ID, ARFCN, PRS
resource ID, PRS resource set ID for
each measurement
DL-PRS-RSRP measurement
UE Rx-Tx time difference
measurement
Time stamp of the measurement
Quality for each measurement
TA offset used by UE
UE Rx TEG IDs, UE Tx TEG IDs, and
UE RxTx TEG IDs associated with
UE Rx-Tx time difference
measurements
LOS/NLOS information for UE
measurements
DL-PRS-RSRPP measurement
The association of UE Tx TEG ID and
SRS

TABLE 8.10.2.3-1
Assistance data that may be transferred from gNB to the LMF
Information

PCI, GCI, ARFCN and TRP IDs of the TRPs served by the
gNB
Timing information of TRPs served by the gNB
DL-PRS configuration of the TRPs served by the gNB
SSB information of the TRPs (the time/frequency
occupancy of SSBs)
Spatial direction information of the DL-PRS Resources of
the TRPs served by the gNB
Geographical coordinates information of the DL-PRS
Resources of the TRPs served by the gNB
TRP type
On-demand DL-PRS information
TRP Tx TEG association information

The configuration data for a target UE that may be transferred from the serving gNB to the LMF is listed in Table 8.10.2.3-2.

TABLE 8.10.2.3-2
UL information/UE configuration data that may
be transferred from serving gNB to the LMF
UE configuration data

UE SRS configuration
SFN initialization time for the SRS configuration

The measurement results that may be signaled from gNBs to the LMF is listed in Table 8.10.2.3-3.

TABLE 8.10.2.3-3
Measurement results that may be transferred from gNBs to the LMF
Measurement results

NCGI and TRP ID of the measurement
gNB Rx-Tx time difference measurement
UL-SRS-RSRP
UL-SRS-RSRPP
UL Angle of Arrival (azimuth and/or elevation) ^{NOTE 1}
Multiple UL Angle of Arrival (azimuth and/or elevation)
^{NOTE 1}
SRS Resource Type ^{NOTE 1}
Time stamp of the measurement
Quality for each measurement
Beam Information of the measurement
LoS/NLoS information for each measurement
ARP ID of the measurement
^{NOTE 1}:
When used with UL-AoA for hybrid positioning.

The requested UL-SRS transmission characteristics information that may be signaled from the LMF to the gNB is listed in Table 8.10.2.4-1.

TABLE 8.10.2.4-1
Requested UL-SRS transmission characteristics
information that may be transferred from LMF to gNB.
Information

Number Of Transmissions/duration for which the UL-SRS is
requested
Bandwidth
Resource type (periodic, semi-persistent, aperiodic)
Number of requested SRS resource sets and SRS resources per set
Pathloss reference:
PCI, SSB Index
DL-PRS ID, DL-PRS Resource Set ID, DL-PRS Resource
ID
Spatial relation info
PCI, SSB Index
DL-PRS ID, DL-PRS Resource Set ID, DL-PRS Resource
ID
NZP CSI-RS Resource ID
SRS Resource ID
Positioning SRS Resource ID
Periodicity of the SRS for each SRS resource set
SSB Information
Carrier frequency of SRS transmission bandwidth

The TRP measurement request information that may be signaled from the LMF to the gNBs is listed in Table 8.10.2.4-2.

TABLE 8.10.2.4-2
TRP Measurement request information that
may be transferred from LMF to gNBs.
Information

TRP ID, and NCGI of the TRP to receive UL-SRS
UE-SRS configuration
UL timing information together with timing uncertainty, for
reception of SRS by candidate TRPs
Report characteristics for the measurements
Measurement Quantities
Measurement periodicity
Measurement beam information request
Search window information
Expected UL AoA/ZoA and uncertainty range
Number of TRP Rx TEGs
Number of TRP RxTx TEGs
Response time
Measurement characteristics request indicator
Measurement time occasions for a measurement instance

The Positioning Activation/Deactivation request information that may be signaled from the LMF to the gNB is listed in Table 8.10.2.4-3.

TABLE 8.10.2.4-3
Requested positioning activation/deactivation
information that may be transferred from LMF to gNB.
Information

SP UL-SRS:
Activation or Deactivation request
Positioning SRS Resource Set ID which is to be
activated/deactivated
Spatial relation for Resource IDᵢ
Activation Time
Aperiodic UL-SRS
Aperiodic SRS Resource Trigger List
Activation Time
UL-SRS:
Release all

### 8.10.3 Multi-RTT Positioning Procedures

The procedures described in this clause support Multi-RTT positioning measurements obtained by the UE and TRPs/gNB.

### 8.10.3.1 Procedures Between LMF and UE

### 8.10.3.1.1 Capability Transfer Procedure

The Capability Transfer procedure for Multi-RTT positioning is described in clause 7.1.2.1.

### 8.10.3.1.2 Assistance Data Transfer Procedure

### 8.10.3.1.2.1 Assistance Data Transfer Between LMF and UE

The purpose of this procedure is to enable the LMF to provide assistance data to the UE (e.g., as part of a positioning procedure) and the UE to request assistance data from the LMF (e.g., as part of a positioning procedure). The LMF may provide the pre-configured DL-PRS assistance data (with associated validity criteria) to the UE (before or during an ongoing LPP positioning session), to be utilized for potential positioning measurements at a future time. Pre-configured DL-PRS assistance data may consist of multiple instances, where each instance is applicable to a different area within the network. One or more assistance data instances may be provided in one or more LPP Assistance Data messages.

If a UE receives assistance data for a TRP for which it has already stored assistance data, it overwrites the stored assistance data, whereas if a UE receives assistance data for a TRP for which it has not stored assistance data, it maintains its stored assistance data for other TRPs. The TRPs are uniquely identified using a combination of PRS-ID and Cell-ID. The number TRPs for which the UE can store Assistance Data is a UE capability and is indicated by the number of areas a UE can support.

### 8.10.3.1.2.1.1 LMF Initiated Assistance Data Delivery

FIG. 4 (8.10.3.1.2.1.1-1) shows the Assistance Data Delivery operations 400 for the Multi-RTT positioning method when the procedure is initiated by the LMF 410.
(1) The LMF 410 determines that assistance data needs to be provided to the UE 420 (e.g., as part of a positioning procedure) and sends an LPP Provide Assistance Data message 430 to the UE 420. This message may include any of the Multi-RTT positioning assistance data defined in Table 8.10.2.1-1.

### 8.10.3.1.2.1.2 UE Initiated Assistance Data Transfer

FIG. 5 (8.10.3.1.2.1.2-1) shows the Assistance Data Transfer operations 500 for the Multi-RTT positioning method when the procedure is initiated by the UE 510.
(1) The UE 510 determines that certain Multi-RTT positioning assistance data are desired (e.g., as part of a positioning procedure when the LMF 520 provided assistance data are not sufficient for the UE 510 to fulfil the request) and sends an LPP Request Assistance Data message 530 to the LMF 520. This request includes an indication of which specific Multi-RTT assistance data are requested. Additional information concerning the UE's 510 approximate location and serving and neighbour cells may also be provided in the Request Assistance Data message and/or in an accompanying Provide Location Information message to help the LMF 520 provide appropriate assistance data. This additional data may include the UE's 510 last known location if available, the cell IDs of the UE 510 serving NG-RAN node and possibly neighbour NG-RAN nodes, as well as NR E-CID measurements.
(2) The LMF 520 provides the requested assistance in an LPP Provide Assistance Data message 540, if available at the LMF 520. If any of the UE 510 requested assistance data in step (1) are not provided in step 2, the UE 510 shall assume that the requested assistance data are not supported, or currently not available at the LMF 520. If none of the UE 510 requested assistance data in step (1) can be provided by the LMF 520, return any information that can be provided in an LPP message of type Provide Assistance Data which includes a cause indication for the not provided assistance data.

### 8.10.3.1.3 Location Information Transfer Procedure

The purpose of this procedure is to enable the LMF to request position measurements from the UE, or to enable the UE to provide location measurements to the LMF for position calculation.

### 8.10.3.1.3.1 LMF-Initiated Location Information Transfer Procedure

FIG. 6 (8.10.3.1.3.1-1) shows the Location Information Transfer operations 600 for the Multi-RTT positioning method when the procedure is initiated by the LMF 610.
(1) The LMF 610 sends an LPP Request Location Information message 630 to the UE 620. This request includes indication of Multi-RTT measurements requested, including any needed measurement configuration information, and required response time.
(2) The UE 620 obtains Multi-RTT measurements as requested in step 1. The UE 620 then sends an LPP Provide Location Information message 640 to the LMF 610, before the Response Time provided in step (1) elapsed, and includes the obtained Multi-RTT measurements. If the UE 620 is unable to perform the requested measurements, or the Response Time elapsed before any of the requested measurements were obtained, the UE 620 returns any information that can be provided in an LPP message of type Provide Location Information which includes a cause indication for the not provided location information.

### 8.10.3.1.3.2 UE-Initiated Location Information Delivery Procedure

FIG. 7 (8.10.3.1.3.2-1) shows the Location Information Delivery procedure operations 700 for the Multi-RTT positioning method when the procedure is initiated by the UE 710.
(1) The UE 710 sends an LPP Provide Location Information message 730 to the LMF 720. The Provide Location Information message 730 may include any UE Multi-RTT measurements already available at the UE.

### 8.10.3.2 Procedures Between LMF and gNB

### 8.10.3.2.1 Assistance Data Delivery Between LMF and gNB

The purpose of these procedures is to enable the gNB to provide assistance data described in Table 8.10.2.3-1 to the LMF, for subsequent delivery to the UE using the procedures of clause 8.10.3.1.2.1 or for use in the calculation of positioning estimates at the LMF or enable the LMF to request UL-SRS configuration information from the serving gNB of a target UE.

FIG. 8 (8.10.3.2.1-1) shows the TRP Information Exchange operation 800 from the gNB 810 to the LMF 820 for the Multi-RTT positioning method.
(1) The LMF 820 determines that certain TRP configuration information is desired (e.g., as part of a periodic update or as triggered by OAM) and sends an NRPPa TRP INFORMATION REQUEST message 830 to the gNB. 810 This request includes an indication of which specific TRP configuration information is requested.
(2) The gNB 810 provides the requested TRP information in an NRPPa TRP INFORMATION RESPONSE message 840, if available at the gNB 810. If the gNB 810 is not able to provide any information, it returns an TRP INFORMATION FAILURE message 840 indicating the cause of the failure.

FIG. 9 (8.10.3.2.1-2) shows the UL information Delivery operation 900 from the serving gNB 910 to the LMF 920.
(1) The LMF 920 sends a NRPPa message POSITIONING INFORMATION REQUEST 930 to the serving gNB 910 of the target UE to request UE SRS configuration information. If the message includes the Requested UL-SRS Transmission Characteristics as listed in Table 8.10.2.4-1, the gNB 910 should take this information into account when configuring UL-SRS transmissions for the UE.
(2) The serving gNB 910 determines the UE SRS configuration to be allocated for the UE and sends NRPPa message POSITIONING INFORMATION RESPONSE 940 to the LMF 920 that includes the UE SRS configuration defined in Table 8.10.2.3-2. If the serving gNB 910 is not able to provide the requested information, it returns a failure message indicating the cause of the failure.
(3) If a change has occurred in the UE SRS configuration during the UE SRS time duration requested at step 1, the gNB 910 sends a POSITIONING INFORMATION UPDATE message 950 to the LMF 920. This message contains, in the case of a change in UE SRS configuration parameters, the UE SRS configuration information for all cells with UE SRS configured, or an indication that the UE SRS configuration has been released in the UE.

### 8.10.3.2.2 Location Information Transfer/Assistance Data Transfer Procedure

The purpose of this procedure is to enable the LMF to request position measurements from a gNB for position calculation of the UE and also provide necessary assistance data to the gNB.

FIG. 10 (8.10.3.2.2-1) shows the messaging 1000 between the LMF 1010 and the gNB 1020 to perform this procedure.
(1) The LMF 1010 sends a NRPPa message 1030 to the selected gNB 1020 to request Multi-RTT measurement information. The message 1030 includes any information required for the gNB 1020 to perform the measurements as defined in Table 8.10.2.4-2.
(2) If the report characteristics in step 1 is set to “on demand”, the gNB 1020 obtains the requested Multi-RTT measurements and returns them in a Measurement Response message 1040 to the LMF 1010. The Measurement Response message 1040 includes the obtained Multi-RTT measurements as defined in Table 8.10.2.3-3. If the report characteristics in step 1 is set to “periodic”, the gNB 1020 replies with a Measurement Response message 1040 without including any measurements in the message. The gNB 1020 then periodically initiates the Measurement Report procedure in step 3 for the Multi-RTT measurements, with the requested reporting periodicity. If the gNB 1020 is not able to accept the Measurement Request message 1030 in step 1, the gNB 1020 returns a failure message indicating the cause of the failure.
(3) The gNB 1020 periodically provides the Multi-RTT measurements in a Measurment Report message 1050 as defined in Table 8.10.2.3-3. to the LMF 1010 if that was requested at step 1.
(4) At any time after step 2, the LMF 1010 may send a Measurement Update message 1060 to the gNB 1020 providing updated information required for the gNB 1020 to perform the Multi-RTT measurements as defined in Table 8.10.2.4-2. Upon receiving the message, the gNB 1020 overwrites the previously received measurement configuration information.
(5) If the previously requested Multi-RTT measurements can no longer be reported, the gNB 1020 notifies the LMF 1010 by sending a Measurement Failure Indication message 1070.
(6) When the LMF 1010 wants to abort an ongoing Multi-RTT measurement it sends a Measurement Abort message 1080 to the gNB 1020.

### 8.10.3.2.3 Positioning Activation/Deactivation Procedure

The purpose of this procedure is to enable the LMF to request activation and deactivation of UL-SRS transmission of the target UE.

FIG. 11 (8.10.3.2.3-1) shows the messaging 1100 between the LMF 1110 and the gNB 1120 to perform this procedure.
1) The LMF 1110 sends the NRPPa Positioning Activation Request message 1130 to the serving gNB 1120 of the target UE to request UL-SRS activation for the target UE. For a semi-persistent UL-SRS, the message 1130 includes an indication of an UL-SRS resource set to be activated and may include information that indicates the spatial relation for the semi-persistent UL-SRS resource to be activated, as listed in Table 8.10.2.4-3. For an aperiodic UL-SRS, the message 1130 may include aperiodic SRS Resource trigger list to indicate the UL-SRS resource to be activated.
(2) For semi-persistent UL-SRS, the serving gNB 1120 may then activate the configured semi-persistent UL-SRS resource sets by sending the SP Positioning SRS Activation/Deactivation MAC CE command 1140 as specified in TS 38.321 [39]. For aperiodic UL-SRS, the serving gNB 1120 may then activate the configured aperiodic UL-SRS resource sets by sending the DCI as specified in TS 38.212 [40]. If the UL-SRS has been successfully activated as requested in step 1, the gNB 1120 sends the NRPPa Positioning Activation Response message 1140 to the LMF 1110. The serving gNB 1120 may include a system frame number and a slot number in the NRPPa Positioning Activation Response message 1140 to the LMF 1110. If the serving gNB 1120 is not able to fulfil the request from step 1, it returns the Positioning Activation Failure message 1140 indicating the cause of the failure.
(3) If a previously activated UL-SRS should be deactivated, or the UL-SRS transmission should be released, the LMF 1110 sends the NRPPa Positioning Deactivation message 1150 to the serving gNB 1120 of the target device to request deactivation of UL-SRS resource sets, or release all the UL-SRS resources. This message includes an indication of the UL-SRS resource set to be deactivated, or an indication of releasing all UL-SRS resources.

### 8.10.4 Sequence of Procedure for Multi-RTT Positioning

FIG. 12 (8.10.4-1) shows the messaging 1200 between the LMF 1202, the gNBs 1204 and 1206, and the UE 1208 to perform LMF-initiated Location Information Transfer Procedure for Multi-RTT.
0. The LMF 1202 may use the procedure 1210 in Figure 8.10.3.2.1-1 to obtain the TRP information required for Multi-RTT positioning.
1. The LMF 1202 may request the positioning capabilities of the target device using the LPP Capability Transfer procedure 1212 described in clause 8.10.3.1.1.
2. The LMF 1202 sends a NRPPa POSITIONING INFORMATION REQUEST message 1214 to the serving gNB 1204 to request UL information for the target device 1208 as described in Figure 8.10.3.2.1-2.
3. The serving gNB 1204 determines 1216 the resources available for UL-SRS and configures the target device 1208 with the UL-SRS resource sets at message 1218.
4. The serving gNB 1204 provides the UL-SRS configuration information to the LMF 1202 in a NRPPa POSITIONING INFORMATION RESPONSE message 1220.

NOTE: It is up to implementation on whether SRS configuration is provided earlier than DL-PRS configuration.
5. In the case of semi-persistent or aperiodic SRS, the LMF 1202 may request activation of UE SRS transmission by sending a NRPPa Positioning Activation Request message 1222 to the serving gNB 1204 of the target device 1208 as described in clause 8.10.3.2.3. The gNB 1204 then activates the UE SRS transmission 1124 and sends a NRPPa Positioning Activation Response message 1226. The target device 1208 begins the UL-SRS transmission according to the time domain behavior of UL-SRS resource configuration.
6. The LMF 1202 provides the UL information to the selected gNBs 1204 and 1206 in a NRPPa MEASUREMENT REQUEST message 1228 as described in clause 8.10.3.2.2. The message includes all information required to enable the gNBs/TRPs to perform the UL measurements.
7. The LMF 1202 sends a LPP Provide Assistance Data message 1230 to the target device 1208 as described in clause 8.10.3.1.2.1. The message 1230 includes any required assistance data for the target device to perform the necessary DL-PRS measurements.
8. The LMF 1202 sends a LPP Request Location Information message 1232 to request Multi-RTT measurements.
9a: The target device 1208 performs the DL-PRS measurements 1234 from all gNBs 1204 and 1206 provided in the assistance data at step 7.
9b: Each gNB 1204 and 1206 configured at step 6 measures 1236 the UE SRS transmissions from the target device.
10. The target device 1208 reports the DL-PRS measurements for Multi-RTT to the LMF 1202 in a LPP Provide Location Information message 1238.
11. Each gNB 1204 and 1206 reports the UE SRS measurements to the LMF 1202 in a NRPPa Measurement Response message 1240 as described in clause 8.10.3.2.2.
12. The LMF 1202 sends a NRPPa POSITIONING DEACTIVATION message 1242 to the serving gNB 1204 as described in clause 8.10.3.2.3.
13. The LMF 1202 determines the RTTs from the UE and gNB Rx-Tx time difference measurements for each gNB for which corresponding UL and DL measurements were provided at steps 10 and 11 and calculates the position of the target device.

### Background on Transmission Timing

### Transmission Timing is Defined in 38.133:

The uplink frame transmission takes place (N_{TA}+N_{TA offset})×T_{c} before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the STAG.

One may note here that if there is no carrier aggregation (CA) or dual connectivity (DC) the reference cell is simply the single serving cell. In case of CA/DC the reference cell is one of the serving cells.

The RAN4 requirements for TX timing are very relaxed but in practice the accuracy is much better or at least the drift with time is typically small.

To keep track of uplink frame timing the UE typically tunes an oscillator to the RX frequency of the reference cell (using e.g. the CSI-RS for tracking transmitted from the reference cell for tuning) and use that oscillator as a UE clock. In addition, the UE regularly measures the time of arrival of the first path (again using e.g. the CSI-RS for tracking) to check the uplink frame timing relative to the DL frame timing. If a deviation from the stipulated relative timing is seen, then an autonomous timing adjustment of the UL frame timing is performed in accordance with rules described in 38.133. The UE also adjusts the UL frame timing after receiving a TA command, changing N_{TA}.

The required accuracy of the uplink frame transmission timing is very low. It may deviate with ±Tₑ around the stipulated offset of (N_{TA}+N_{TA offset})×T_{c}, where Tₑ is between 3. 64. T_{c}≈98 ns and 12·64·T_{c}≈391 ns depending on subcarrier spacing. These requirements have been set based on the initial frame timing e.g. after a DRX cycle under the assumption that there has been a SSB available to the UE within the previous 160 ms. One may note that if it's not initial frame timing and the UE is using a full bandwidth TRS (CSI-RS for tracking) to track frequency and time, the UE should be able to follow the stipulated frame timing with extremely much better precision. There are, however, no such requirements.

Tuning to the DL frequency means that the UE clock is affected by doppler shifts in such a way that it compensates for the movements of the UE to keep the UL TX frame timing relative to the DL RX frame timing constant even though the propagation time changes. Still, due to imperfect tuning and/or disruptive channel events, such as blocking of the first path or unblocking of a new first path, the TX UL frame timing relative to the DL RX frame timing does change, eventually resulting in timing adjustments.

UE movements and the corresponding change in propagation time also result in misalignment of RX UL frames at the gNB, triggering the gNB to send a TA command to the JE.

A change in TX UL frame timing means a change in UL TX frame timing relative to the DL RX frame timing of the reference cell (as defined in 38.133—not positioning reference cell). There are four types of such changes:
1. Timing adjustments due to a TA command from the gNB
2. Changes due to disruptive channel events, such as blocking of the first path or unblocking of a new first path in the channel of the reference cell
3. Changes due to imperfect tuning to the RX DL from the reference cell or drift of the UE oscillator frequency between DL frequency estimates used for tuning
4. Autonomous timing adjustments to correct for changes of type 2 or type 3 above, once detected by the UE

Type 2 and type 3 changes are not known by the UE until at some point the UE measures the TOA of the first path of the reference cell. When such a change is discovered the UE compensates for that change by performing a type 4 timing adjustment. According to requirements, adjustments are only needed to the extent that the deviation is kept within ±Tₑ around the stipulated offset of (N_{TA}+N_{TA offset})×T_{c}.

In 3GPP TS 38.133 v18.0.0 UE transmit timing and timing adjustments are described in section 7.1:

### UE Transmit Timing

### 7.1.1 Introduction

The UE shall have capability to follow the frame timing change of the reference cell in connected state or when transmitting PUSCH on CG resources for SDT in RRC_Inactive. The uplink frame transmission takes place (N_{TA}+N_{TA offset})×Tₑ before the reception of the first detected path (in time) of the corresponding downlink frame from the reference cell. For serving cell(s) in pTAG, UE shall use the SpCell as the reference cell for deriving the UE transmit timing for cells in the pTAG. For serving cell(s) in sTAG, UE shall use any of the activated SCells as the reference cell for deriving the UE transmit timing for the cells in the sTAG. UE initial transmit timing accuracy and gradual timing adjustment requirements are defined in the following requirements.

In the requirements of clause 7.1.2, the term reference cell on a carrier frequency subject to CCA is not available at the UE refers to when at least one SSB is configured by gNB, but the first two successive candidate SSB positions for the same SSB index within the discovery burst transmission window are not available during at least one discovery burst transmission window, at the UE due to DL CCA failures at gNB during the last 1280 ms; otherwise the reference cell on the carrier frequency subject to CCA is considered as available at the UE.

### 7.1.2 Requirements

The UE initial transmission timing error shall be less than or equal to ±Tₑ where the timing error limit value Tₑ is specified in Table 7.1.2-1. This requirement applies:
when it is the first transmission in a DRX cycle for PUCCH, PUSCH and SRS, or it is the PRACH transmission, or it is the msgA transmission, or it is the first transmission sent on the PSCell for activating the deactivated SCG without RACH.
when it is the transmission for PUSCH on CG resources for SDT in RRC_Inactive.

When the UL SCS is 120 kHz or smaller, the UE shall meet the Te requirement for an initial transmission provided that at least one SSB is available at the UE during the last 160 ms. When the UL SCS is 480 kHz the UE shall meet the Te requirement for an initial transmission provided that at least one SSB is available in the last 80 ms. When the UL SCS is 960 kHz the UE shall meet the Te requirement for an initial transmission provided that at least one SSB is available in the last 40 ms. The reference point for the UE initial transmit timing control requirement shall be the downlink timing of the reference cell minus (N_{TA}+N_{TA offset})×T. The downlink timing is defined as the time when the first path (in time) of the corresponding downlink frame used by the UE to determine downlink timing is received from the reference cell at the UE antenna. N_{TA} for PRACH is defined as 0.

(N_{TA}+N_{TA offset})×T_{c} (in T_{c} units) for other channels is the difference between UE transmission timing and the downlink timing immediately after when the last timing advance in clause 7.3 was applied. N_{TA} for other channels is not changed until next timing advance is received. The value of N_{TA offset} depends on the duplex mode of the cell in which the uplink transmission takes place and the frequency range (FR). N_{TA offset} is defined in Table 7.1.2-2.

TABLE 7.1.2-1
Tₑ Timing Error Limit

| Frequency | SCS of SSB | SCS of uplink | |
|---|---|---|---|
| Range | signals (kHz) | signals (kHz) | Tₑ |
| 1 | 15 | 15 | 12*64*T_{c} |
| | | 30 | 10*64*T_{c} |
| | | 60 | 10*64*T_{c} |
| | 30 | 15 | 8*64*T_{c} |
| | | 30 | 8*64*T_{c} |
| | | 60 | 7*64*T_{c} |
| 2-1 | 120 | 60 | 3.5*64*T_{c} |
| | | 120 | 3.5*64*T_{c} |
| | 240 | 60 | 3*64*T_{c} |
| | | 120 | 3*64*T_{c} |
| 2-2 | 120 | 120 | 3.5*64*T_{c} |
| | | 480 | [1.58]*64*T_{c} |
| | 480 | 120 | 2.86*64*T_{c} |
| | | 480 | [1.35]*64*T_{c} |
| | | 960 | [0.90]*64*T_{c} |
| | 960 | 120 | 2.80*64*T_{c} |
| | | 480 | [1.13]*64*T_{c} |
| | | 960 | [0.86]*64*T_{c} |

Note 1:
T_{c} is the basic timing unit defined in TS 38.211

TABLE 7.1.2-2
The Value of N_{TA offset}

| Frequency range and band of cell | N_{TA offset} | |
|---|---|---|
| used for uplink transmission | (Unit: T_{c}) | |
| FR1 FDD or TDD band with neither E-UTRA- | 25600 | (Note 1) |
| NR nor NB-IoT-NR coexistence case | | |
| FR1 FDD band with E-UTRA-NR and/or NB- | 0 | (Note 1) |
| IoT-NR coexistence case | | |
| FR1 TDD band with E-UTRA-NR and/or NB- | 39936 | (Note 1) |
| IoT-NR coexistence case | | |

| | |
|---|---|
| FR2 | 13792 |

(Note 1):
The UE identifies N_{TA offset} based on the information n-TimingAdvanceOffset as specified in TS 38.331. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 and the value 39936 of N_{TA offset} can also be provided for a FDD serving cell.
Note 2:
Void

When it is not the first transmission in a DRX cycle or there is no DRX cycle, and when it is the transmission for PUCCH, PUSCH and SRS transmission, the UE shall be capable of changing the transmission timing according to the received downlink frame of the reference cell except when the timing advance in clause 7.3 is applied.

### Table 7.1.2-3: Void

If the UE uses a reference cell on a carrier frequency subject to CCA for deriving the UE transmit timing, then the UE shall meet all the transmit timing requirements defined in clause 7.1.2 provided that the reference cell is available at the UE. If the reference cell is not available at the UE on a carrier frequency subject to CCA, then the UE is allowed to transmit in the uplink provided that the UE meets all the transmit timing requirements defined in clause 7.1.2; otherwise the UE shall not transmit any uplink signal.

If a reference cell on a carrier frequency belonging to the PTAG, which is subject to CCA, is not available at the UE then the UE is allowed to use any of available activated SCell(s) at the UE in PTAG as a new reference cell. If the SCell used as reference cell is deactivated, or becomes not available, the UE is allowed to use another active serving cell in PTAG as new reference cell.

If a reference cell on a carrier frequency belonging to the STAG, which is subject to CCA is not available at the UE then the UE is allowed to use any of available activated SCell(s) at the UE in STAG as a new reference cell.

### 7.1.2.1 Gradual Timing Adjustment

Requirements in this section shall apply regardless of whether the reference cell is on a carrier frequency subject to CCA or not.

When the transmission timing error between the UE and the reference timing exceeds ±Tₑ then the UE is required to adjust its timing to within ±Tₑ. The reference timing shall be (N_{TA}+N_{TA offset})×T_{c} before the downlink timing of the reference cell. All adjustments made to the UE uplink timing shall follow these rules:
1) The maximum amount of the magnitude of the timing change in one adjustment shall be T_{q}.
2) The minimum aggregate adjustment rate shall be Tₚ per second.
3) The maximum aggregate adjustment rate shall be T_{q} per 200 ms for SCS of UL signals smaller or equal to 120 kHz and 100 ms for SCS of upling signals larger or equal to 480 kHz.
where the maximum autonomous time adjustment step T_{q} and the aggregate adjustment rate Tₚ are specified in Table 7.1.2.1-1.

TABLE 7.1.2.1-1
T_{q} Maximum Autonomous Time Adjustment Step
and Tₚ Minimum Aggregate Adjustment rate

| Frequency | SCS of uplink | | |
|---|---|---|---|
| Range | signals (kHz) | T_{q} | Tₚ |
| 1 | 15 | 5.5*64*T_{c} | 5.5*64*T_{c} |
| | 30 | 5.5*64*T_{c} | 5.5*64*T_{c} |
| | 60 | 5.5*64*T_{c} | 5.5*64*T_{c} |
| 2-1 | 60 | K*64*T_{c} | 2.5*64*T_{c} |
| | 120 | K*64*T_{c} | 2.5*64*T_{c} |
| 2-2 | 120 | 2.5*64*T_{c} | 2.5*64*T_{c} |
| | 480 | [0.8]*64*T_{c} | [0.8]*64*T_{c} |
| | 960 | [0.8]*64*T_{c} | [0.8]*64*T_{c} |

NOTE 1:
T_{c} is the basic timing unit defined in TS 38.211 [6]
NOTE 2:
When highSpeedMeasFlagFR2-r17 is configured for UE supporting power class 6, K = 4.5; otherwise, K = 2.5.

The aforementioned discussion focuses on NR in terrestrial network. The following excerpt is about the changes introduced for uplink transmit timing for NR in NTN.

### UE Transmit Timing for Satellite Access

### 7.1C.1 Introduction

The UE shall have capability to follow the frame timing change of the reference cell in connected state. The uplink frame transmission takes place

$$( {N}_{T A} + {N}_{TA - offset} + {N}_{TA , adj}^{common} + {N}_{TA , adj}^{UE} ) \times {T}_{c}$$

before the reception of the first detected path (in time) of the corresponding downlink frame from the reference cell. UE initial transmit timing accuracy and gradual timing adjustment requirements are defined in the following requirements.

### 7.1C.2 Requirements

The UE initial transmission timing error shall be less than or equal to ±T_{e_NTN} where the timing error limit value T_{e_NTN} is specified in Table 7.1C.2-1. This requirement applies:
when it is the first transmission in a DRX cycle for PUCCH, PUSCH and SRS, or it is the PRACH transmission, or it is the msgA transmission.

The UE shall meet the T_{e_NTN} requirement for an initial transmission provided that at least one SSB is available at the UE during the last 160 ms. and the UE has a validity time running for N_{TA,common} and N_{TA,UE-specific}. The reference point for the UE initial transmit timing control requirement shall be the downlink timing of the reference cell

$$( {N}_{T A} + {N}_{TA - offset} + {N}_{TA , adj}^{common} + {N}_{TA , adj}^{UE} ) \times {T}_{c} .$$

The downlink timing is defined as the time when the first path (in time) of the corresponding downlink frame used by the UE to determine downlink timing is received from the reference cell at the UE antenna.

N_{TA} for PRACH is defined as 0.

$$( {N}_{T A} + {N}_{TA - offset} + {N}_{TA , adj}^{common} + {N}_{TA , adj}^{UE} ) \times {T}_{c}$$

(in T_{c} units) for other channels is the difference between UE transmission timing and the downlink timing immediately after when the last timing advance in clause 7.3 was applied, or after the last update in

$${N}_{TA , adj}^{common} or {N}_{TA , adj}^{UE} .$$

The value of N_{TA-offset} depends on the duplex mode of the cell in which the uplink transmission takes place and the frequency range (FR). N_{TA-offset} is defined in Table 7.1.2-2.

$${N}_{TA , adj}^{common} or {N}_{TA , adj}^{UE}$$

are as defined in TS38.211 [6].

TABLE 7.1C.2-1
Tₑ_{_{—}}_{NTN} Timing Error Limit

| Frequency | SCS of SSB | SCS of uplink | |
|---|---|---|---|
| Range | signals (kHz) | signals (kHz) | Tₑ_{_{—}}_{NTN} |
| 1 | 15 | 15 | 29*64*T_{c} |
| | | 30 | 24*64*T_{c} |
| | | 60 | N/A |
| | 30 | 15 | 24*64*T_{c} |
| | | 30 | 22*64*T_{c} |
| | | 60 | N/A |

Note 1:
T_{c} is the basic timing unit defined in TS 38.211 [6]

When it is not the first transmission in a DRX cycle or there is no DRX cycle, and when it is the transmission for PUCCH, PUSCH and SRS transmission, the UE shall be capable of changing the transmission timing according to the received downlink frame of the reference cell, the updating of

$${N}_{TA , adj}^{common}$$

and the updating of

$${N}_{TA , adj}^{UE} ,$$

except when the timing advance in clause 7.3C is applied.

### 7.1C.2.1 Gradual Timing Adjustment

adjust its timing to within ±T_{e_NTN}. The reference timing shall be

$$( {N}_{T A} + {N}_{TA - offset} + {N}_{TA , adj}^{common} + {N}_{TA , adj}^{UE} ) \times {T}_{c}$$

before the downlink timing of the reference cell. All adjustments made to the UE uplink timing shall follow these rules:
1) The maximum amount of the magnitude of the timing change, apart from a change of

$${N}_{TA , adj}^{UE}$$

due to satellite position update and

$${N}_{TA , adj}^{common}$$

between the previous transmission and the current transmission, in one adjustment shall be T_{q_NTN}.
2) The minimum aggregate adjustment rate, apart from a change of

$${N}_{TA , adj}^{UE}$$

due to satellite position update and

$${N}_{TA , adj}^{common}$$

during the last one second, shall be T_{p_NTN} per second.
3) The maximum aggregate adjustment rate, apart from a change of

$${N}_{TA , adj}^{UE}$$

due to satellite position update and

$${N}_{TA , adj}^{common}$$

during the last 200 ms, shall be T_{q_NTN} per 200 ms. Where, the maximum autonomous time adjustment step T_{q_NTN} and the aggregate adjustment rate T_{p_NTN} are specified in Table 7.1C.2.1-1.

TABLE 7.1C.2.1-1
T_{q}_{_{—}}_{NTN} Maximum Autonomous Time Adjustment Step
and Tₚ_{_{—}}_{NTN} Minimum Aggregate Adjustment rate

| Frequency | SCS of uplink | | |
|---|---|---|---|
| Range | signals (kHz) | T_{q}_{_{—}}_{NTN} | Tₚ_{_{—}}_{NTN} |
| 1 | 15 | 5.5*64*T_{c} | 5.5*64*T_{c} |
| | 30 | 5.5*64*T_{c} | 5.5*64*T_{c} |
| | 60 | N/A | N/A |

NOTE:
T_{c} is the basic timing unit defined in TS 38.211 [6]

### SUMMARY

The existing 3GPP positioning methods have been specified for terrestrial LTE and NR systems. To use these methods in NTN for UE location verification, there is a need to enhance the existing 3GPP positioning protocols to account for NTN characteristics such as high propagation delay, moving radio access network, etc.

In NTN, the UE autonomously derives its TA value based on the GNSS location information and the satellite ephemeris and Common TA parameters. However, UE location verification in NTN should not be based on quantities derived from the UE's GNSS location information due to potential trustworthiness issues. Therefore, the TA value reported by the UE to the gNB cannot be trusted as it is derived from the GNSS location information. In addition, even if a TA report were trustworthy, it would not enable the network to calculate the UE's location, but rather a circle where the UE's location could be anywhere on the circle's perimeter. This calls for developing methods to perform location verification that are not based on UE reported TA.

Certain aspects of the disclosure and their embodiments may provide solutions to these or other challenges. Enhanced support of physical layer positioning measurements for multi-RTT based positioning in NTN scenario. Enhanced support for signaling NTN-specific positioning assistance information for multi-RTT based positioning between UE/gNB/LMF in an NTN scenario. Modification of the UE RX-TX time difference measurement for NTN. Modification of the UE RX-TX time difference measurement report for NTN

Certain embodiments may provide one or more of the following technical advantage(s). The proposed solutions enable LMF/AMF/gNB/UE to perform multi-RTT positioning by modifying the existing positioning framework (NRPPa, LPP, physical layer measurements) for network verification of UE location in an NTN system.

According to a first aspect, a method performed by a user equipment (UE) for supporting a network verified UE location in a non-terrestrial network (NTN) is provided. The method includes measuring a UE receive (RX)-transmit (TX) time difference. The method includes transmitting to a network node the UE RX-TX time difference measurement, a fractional part F of the measurement and an integer part I of the measurement. The UE RX-TX time difference is equal to the fractional part F plus the integer part I. The method includes receiving positioning information for network verified UE location.

In some embodiments, the method includes transmitting to the network node timestamp information for the UE RX-TX time difference measurement.

In some embodiments, the received positioning information includes one or more of: (i) satellite ID; (ii) time until a satellite will be available; (iii) time until a NTN cell will be available; or (iv) whether to use a existing Rel-17 UE RX-TX time difference measurement report or a new NTN-specific UE RX-TX time difference measurement report.

In some embodiments, the method includes transmitting to the network node NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, the method includes transmitting to the network node information including one or more of: (i) satellite identification (ID); or (ii) position information for a satellite at each round trip time (RTT) measurement.

According to a second aspect, user equipment (UE) for supporting a network verified user equipment location in a non-terrestrial network (NTN) is provided. The UE comprising processing circuitry. The processing circuitry being configured to cause the UE to: measure a UE receive (RX)-transmit (TX) time difference; transmit to a network node the UE RX-TX time difference measurement, a fractional part F of the measurement and an integer part I of the measurement. The UE RX-TX time difference is equal to the fractional part F plus the integer part I; and receive positioning information for network verified UE location.

According to a third aspect, a method performed by a user equipment (UE) for supporting a network verified UE location in a non-terrestrial network (NTN) is provided. The method includes measuring a UE-RX time difference, a timing advance (TA), and a common TA. The method includes determining a difference D between the sum of measured TA and the common TA, and the UE-RX time difference (D=UE-RX time difference−(TA+common TA)). The method includes transmitting to a network node the measured TA and common TA, and the difference D. The method includes receiving positioning information for network verified UE location.

In some embodiments, the received positioning information includes one or more of: (i) satellite ID; (ii) time until a satellite will be available; (iii) time until a NTN cell will be available; or (iv) whether to use an existing Rel-17 UE RX-TX time difference measurement report or a new NTN-specific UE RX-TX time difference measurement report.

In some embodiments, the method includes transmitting to the network node NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, the method includes transmitting to the network node information including one or more of: (i) satellite identification (ID); or (ii) position information for a satellite at each round trip time (RTT) measurement.

According to a fourth aspect, a user equipment (UE) for supporting a network verified user equipment location in a non-terrestrial network (NTN) is provided. The UE comprising processing circuitry. The processing circuitry being configured to cause the UE to: measure a UE-RX time difference, a timing advance (TA), and a common TA; determine a difference D between the sum of measured TA and the common TA, and the UE-RX time difference (D=UE-RX time difference−(TA+common TA)); transmit to a network node the measured TA and common TA, and the difference D; and receive positioning information for network verified UE location.

According to a fifth aspect, a method performed by a network node for supporting a network verified user equipment (UE) location in a non-terrestrial network (NTN) is provided. The method includes receiving, from a UE, a UE RX-TX time difference measurement, a fractional part F of the measurement and an integer part I of the measurement. The UE RX-TX time difference is equal to the fractional part F plus the integer part I. the method includes determining, based on the received UE RX-TX time difference measurement, fractional part F of the measurement and integer part I of the measurement, positioning information for network verified UE location. The method includes transmitting, to the UE, the determined positioning information for network verified UE location.

In some embodiments, the method includes receiving, from the UE, a network node timestamp information for the UE RX-TX time difference measurement.

In some embodiments, the transmitted positioning information includes one or more of: (i) satellite ID; (ii) time until the satellite will be available; (iii) time until the NTN cell will be available; and (iv) whether to use the existing Rel-17 UE RX-TX time difference measurement report or a new NTN-specific UE RX-TX time difference measurement report.

In some embodiments, the method includes receiving from the UE NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, the method includes receiving from the UE information including one or more of: (i) satellite identification (ID); or (ii) position information for a satellite at each round trip time (RTT) measurement.

According to a sixth aspect, a network node for supporting a network verified user equipment (UE) location in a non-terrestrial network (NTN) is provided. The network node comprising processing circuitry. The processing circuitry being configured to cause the network node to: receive, from a UE, a UE RX-TX time difference measurement, a fractional part F of the measurement and an integer part I of the measurement. The UE RX-TX time difference is equal to the fractional part F plus the integer part I; determine, based on the received UE RX-TX time difference measurement, fractional part F of the measurement and integer part I of the measurement, positioning information for network verified UE location; and transmit, to the UE, the determined positioning information for network verified UE location.

According to a seventh aspect, a method performed by a network node for supporting a network verified user equipment (UE) location in a non-terrestrial network (NTN) is provided. The method includes measuring a UE-RX time difference, a timing advance (TA), and a common TA. The method includes determining a difference D between the sum of measured TA and the common TA, and the UE-RX time difference (D=UE-RX time difference−(TA+common TA)). The method includes receiving from a UE a difference D between the sum of a measured timing advance (TA) and a common TA, and a UE-RX time difference (D=UE-RX time difference−(TA+common TA)). The method includes determining, based on the received measured TA and common TA, and the difference D, positioning information for network verified UE location. The method includes transmitting to the UE positioning information for network verified UE location.

In some embodiments, the transmitted positioning information includes one or more of: (i) satellite ID; (ii) time until a satellite will be available; (iii) time until a NTN cell will be available; or (iv) whether to use a existing Rel-17 UE RX-TX time difference measurement report or a new NTN-specific UE RX-TX time difference measurement report.

In some embodiments, the method includes receiving from the UE NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, the method includes receiving from the UE information including one or more of: (i) satellite identification (ID); or (ii) position information for a satellite at each round trip time (RTT) measurement.

According to an eighth aspect, a network node for supporting a network verified user equipment (UE) location in a non-terrestrial network (NTN) is provided. The network node comprising processing circuitry. The processing circuitry being configured to cause the network node to: measure a UE-RX time difference, a timing advance (TA), and a common TA; determine a difference D between the sum of measured TA and the common TA, and the UE-RX time difference (D=UE-RX time difference−(TA+common TA)); receive from a UE a difference D between the sum of a measured timing advance (TA) and a common TA, and a UE-RX time difference (D=UE-RX time difference−(TA+common TA)); determine, based on the received measured TA and common TA, and the difference D, positioning information for network verified UE location; and transmit to the UE positioning information for network verified UE location.

According to a ninth aspect, a computer program is provided comprising instructions which, when executed by processing circuitry, causes the processing circuitry to perform the methods of any one of the embodiments of the first, third, fifth, and/or seventh aspects.

### BRIEF DESCRIPTION OF THE DRAWINGS

FIG. 1 is a diagram of an example architecture of a satellite network.

FIG. 2 is a diagram of an example of orbital elements.

FIG. 3 is a diagram of an example of time differences and time propagation.

FIG. 4 is a signal flow diagram of an operation.

FIG. 5 is a signal flow diagram of an operation.

FIG. 6 is a signal flow diagram of an operation.

FIG. 7 is a signal flow diagram of an operation.

FIG. 8 is a signal flow diagram of an operation.

FIG. 9 is a signal flow diagram of an operation.

FIG. 10 is a signal flow diagram of an operation.

FIG. 11 is a signal flow diagram of an operation.

FIG. 12 is a signal flow diagram of an operation.

FIG. 13 illustrates a timing diagram according to some embodiments.

FIG. 14 illustrates a timing diagram according to some embodiments.

FIG. 15 illustrates a timing diagram according to some embodiments.

FIG. 16 is a flowchart illustrating a process according to some embodiments.

FIG. 17 is a flowchart illustrating a process according to some embodiments.

FIG. 18 is a flowchart illustrating a process according to some embodiments.

FIG. 19 is a flowchart illustrating a process according to some embodiments.

FIG. 20 is a block diagram of a communication system according to some embodiments.

FIG. 21 is a block diagram of a user equipment according to some embodiments.

FIG. 22 is a block diagram of a network node according to some embodiments.

FIG. 23 is a block diagram of a host according to some embodiments.

FIG. 24 is a block diagram of a virtualization environment according to some embodiments.

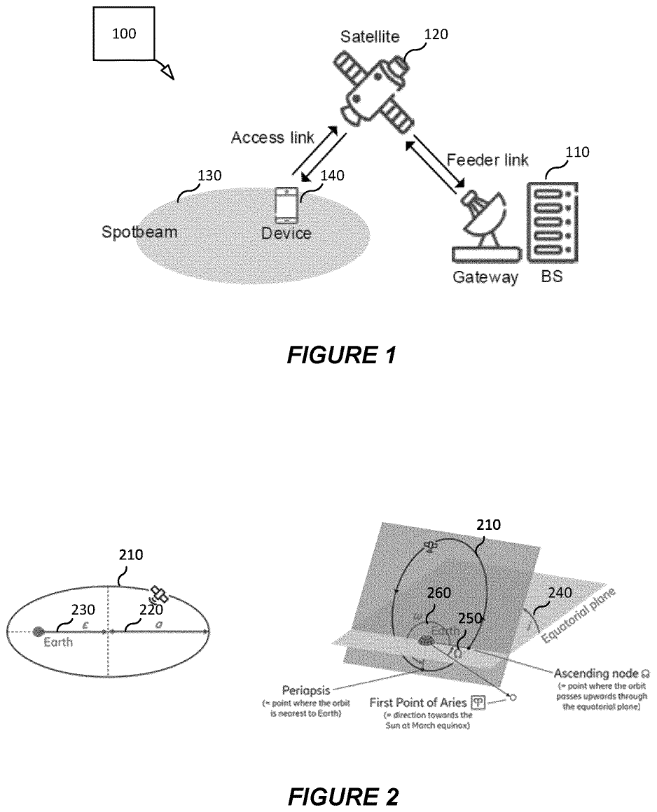

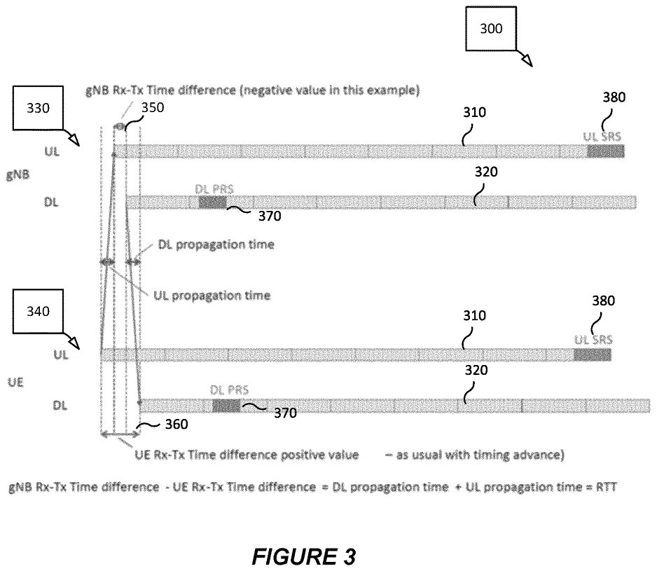

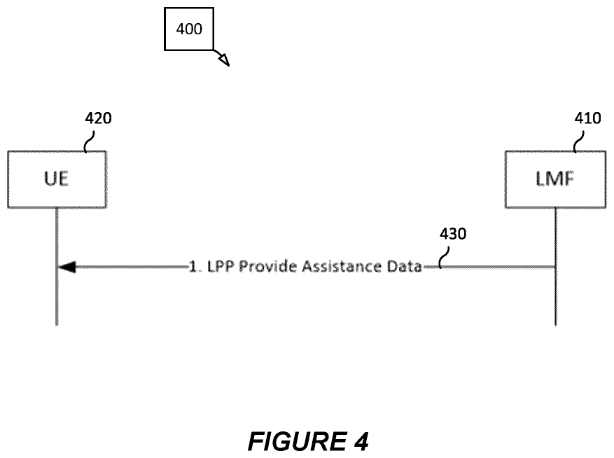

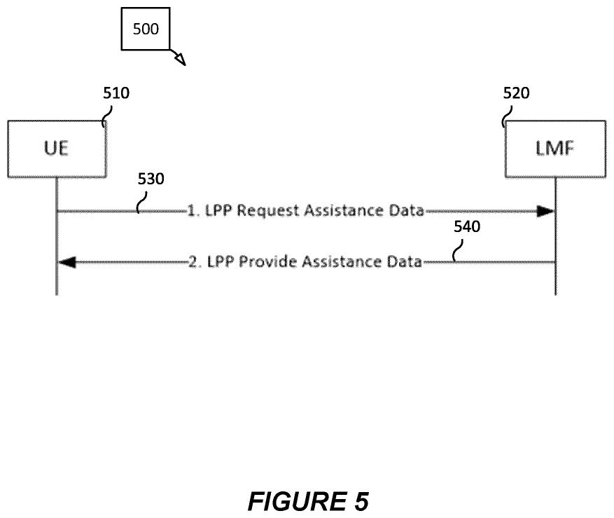

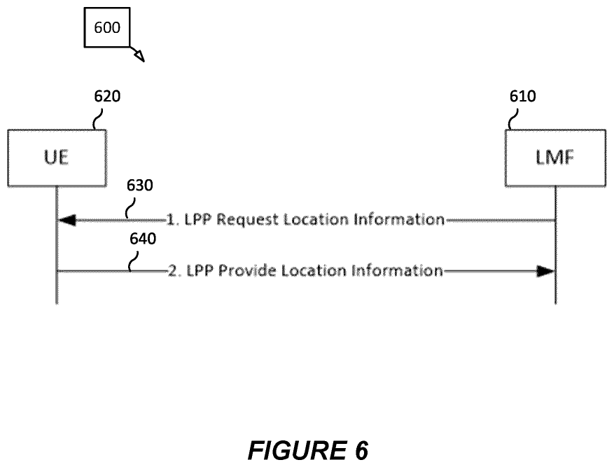

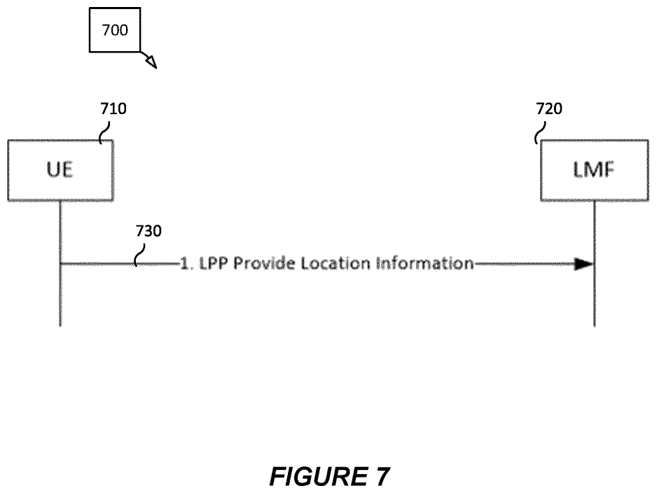

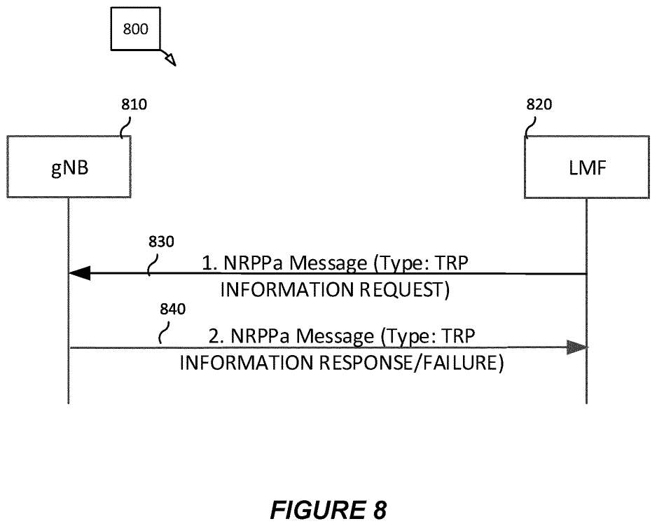

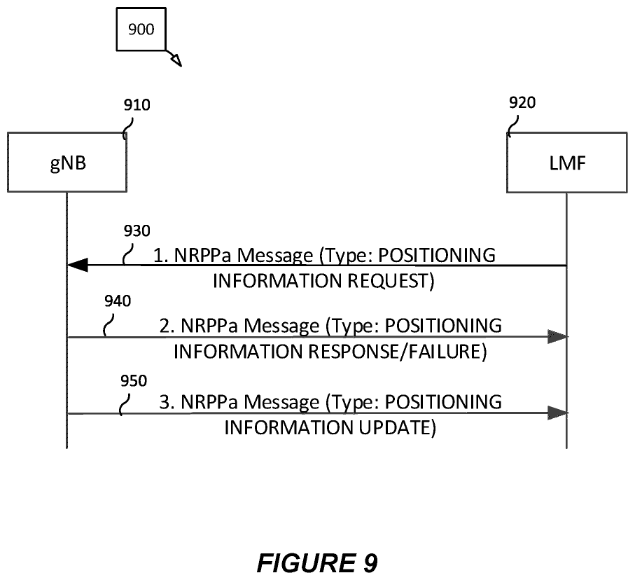

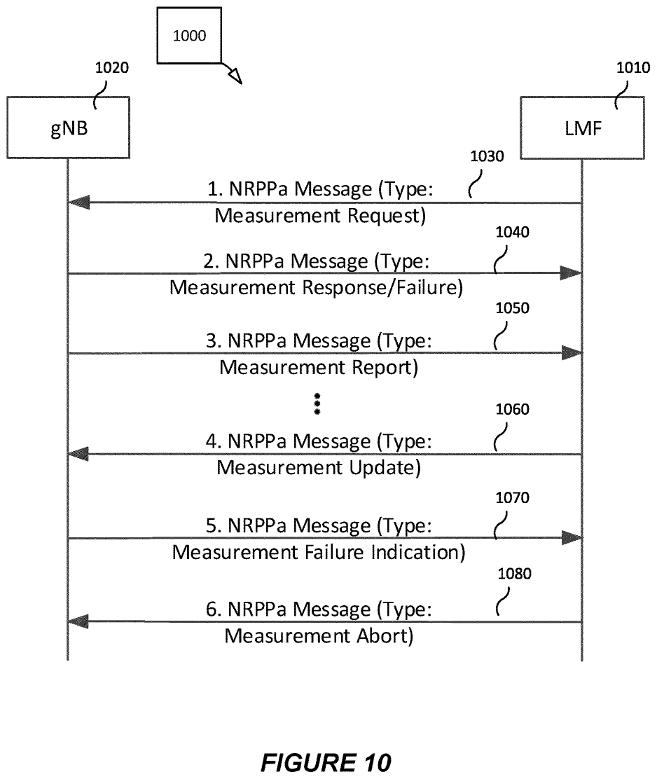

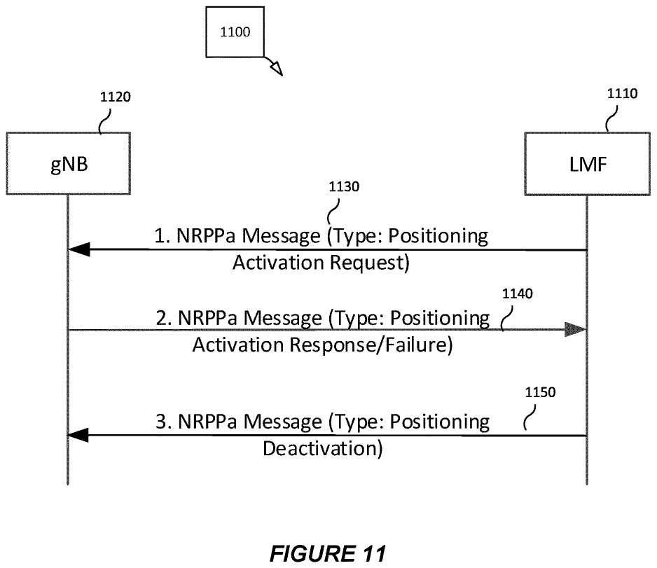

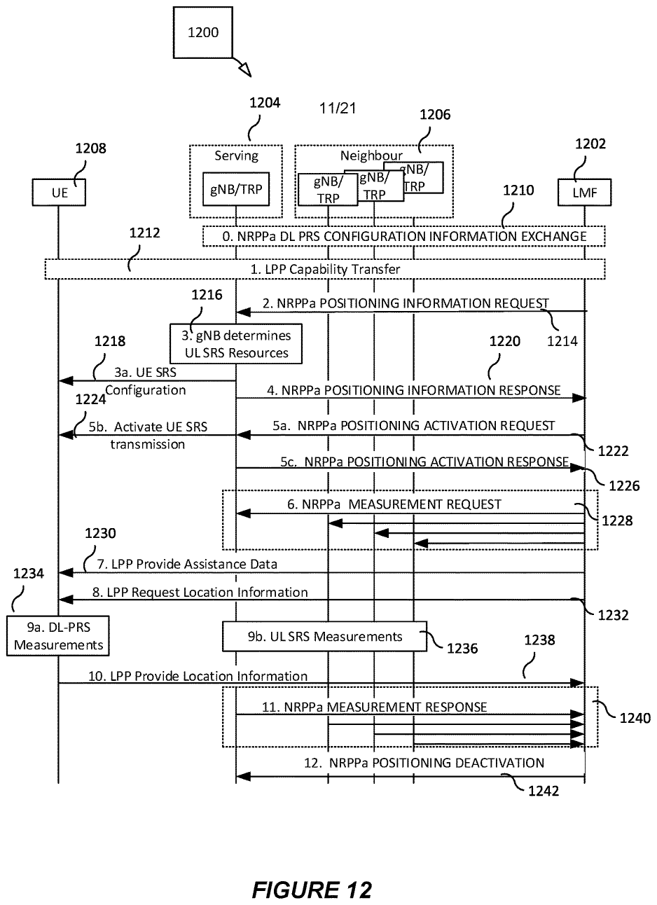

### DETAILED DESCRIPTION

Some of the embodiments contemplated herein will now be described more fully with reference to the accompanying drawings. Embodiments are provided by way of example to convey the scope of the subject matter to those skilled in the art. The embodiments disclosed herein are described mainly in terms of NR NTN, but they are equally applicable in an NTN based on LTE (eMTC/NB-IoT) technology. The term “network” is used in the solution description herein to refer to a network node, which typically will be an gNB (e.g. in a NR based NTN), but which may also be an eNB (e.g. in a LTE based NTN), or a base station or an access point in another type of network, or any other network node with the ability to directly or indirectly communicate with a UE. The term “actual” or “true” UE RX-TX time difference measurement is used herein to refer to the TA, and to differentiate it from the Rel-17 UE RX-TX time difference measurement as defined in 3GPP TS 38.215 version 17.2.0. This is because when the TA is large (e.g., >0.5 ms), the Rel-17 UE RX-TX time difference measurement is not the same as the TA. The term NTN UE is used herein to refer to a UE operating in an NTN cell.

### Physical Layer Enhancements

### UE RX-TX Time Difference in NTN

The UE RX-TX time difference is defined as follows in 3GPP TS 38.215 version 17.2.0:
The UE Rx-Tx time difference is defined as TUE-RX−TUE-TX
Where:
   TUE-RX is the UE received timing of downlink subframe #i from a Transmission Point (TP), defined by the first detected path in time.
   TUE-TX is the UE transmit timing of uplink subframe #j that is closest in time to the subframe #i received from the TP.

According to TS 38.133, the reporting range of UE Rx-Tx time difference is −0.5 ms to +0.5 ms:
“The reporting range for the absolute UE Rx-Tx time difference measurement (TUE Rx-Tx) is defined from −985024′Tc to 985024′Tc with the resolution step of 2k′Tc [ . . . ]”

Before addressing the embodiments, possible cases are described (based on the applied TA value range) to elaborate that the existing UE RX-TX time difference measurement cannot be used for sufficiently accurate positioning with multi-RTT based method in NTN. Hence, in the cases illustrated below, the method specified in 3GPP TS 38.215 version 17.2.0 is used.

### Case 1: Small TA (TA<0.5 ms)

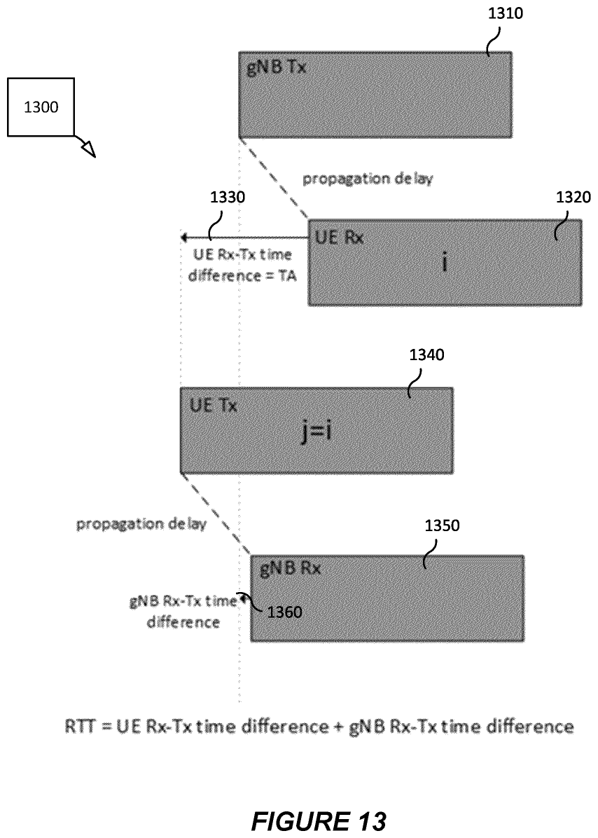

FIG. 13 illustrates a timing diagram 1300 when TA is small. When the TA is small (TA<0.5 ms), j=i in the UE Rx-Tx time difference definition above. gNB transmits a frame 1310 which is received at the UE as frame i 1320 after a propagation delay. After a UE Rx-Tx time difference 1330, the UE transmits frame j 1340 which is received as frame 1350 at the gNB after a propagation delay. In this case, UE Rx-Tx time difference 1330 is equal to the TA. This case is illustrated with reference to FIG. 13. The RTT can be calculated as RTT=(UE Rx-Tx time difference) 1330+(gNB Rx-Tx time difference) 1360.

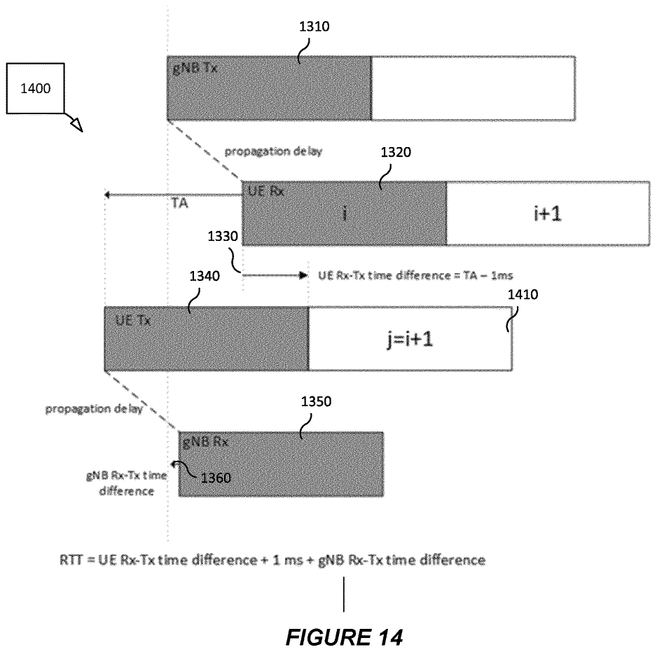

FIG. 14 illustrates a timing diagram 1400 when TA is moderate. Case 2: Moderate TA (0.5 ms<TA<1 ms)

When 0.5 ms<TA<1 ms, uplink subframe j=i+1 1410 is closer to downlink subframe i 1320. In this case, UE Rx-Tx time difference 1330 is negative and equal to (TA−1 ms). This case is illustrated with reference to FIG. 14. The RTT can be calculated as RTT=(UE Rx-Tx time difference) 1330+(gNB Rx-Tx time difference) 1360+ (1 ms). Since UE Rx-Tx time difference 1330 is negative in this case and positive in the previous case, it should be possible to know that 1 ms should be added in this case without any additional information, as long as it can be assumed that TA is always <1 ms.

### Case 3: Large TA (TA>1 ms)

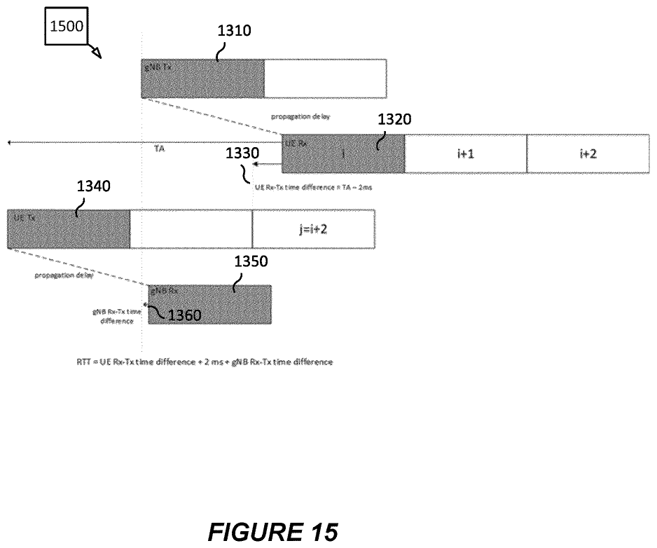

FIG. 15 illustrates a timing diagram 1500 when TA is large. When TA>1 ms, as will be typically the case in NTN, the existing UE RX-TX time difference measurement 1330 will lead to erroneous calculation of RTT. This case is illustrated with reference to FIG. 15. As an example, see FIG. 15, where the TA is ~2.3 ms, j=i+2, UE Rx-Tx time difference=(TA−2 ms) and RTT=(UE Rx-Tx time difference) 1330+ (gNB Rx-Tx time difference) 1360+(2 ms).

### UE RX-TX Measurement in NTN

As evident from cases 2 and 3, a UE in an NTN cell will not end up measuring its intended or true UE RX-TX time difference that is needed to calculate the RTT in an NTN scenario if the Rel-17 definition of the UE RX-TX time difference measurement (as specified in 3GPP TS 38.215 version 17.2.0) is followed.

In some embodiments, the UE RX-TX time difference measurement is redefined for a UE in an NTN cell such that T_{UE-TX} is the UE transmit timing of the uplink subframe #i if TUE-RX is the UE received timing of downlink subframe #i from a Transmission Point (TP). With this modification, UE RX-TX time difference will better approximate the large TA values in NTN. In one example, the UE RX-TX time difference measurement definition can be modified as follows:
“The UE Rx-Tx time difference in an NTN cell is defined as T_{UE-RX}−T_{UE-TX}
Where:
T_{UE-RX} is the UE received timing of downlink subframe #i from a Transmission Point (TP) [18], defined by the first detected path in time.
T_{UE-TX} is the UE transmit timing of uplink subframe #i.”

### UE RX-TX Measurement Reporting in NTN

The true UE RX-TX time difference measurement TUE in an NTN cell can be expressed as T_{UE}=F+I, where F∈(−0.5, 0.5) is the fractional part and I∈(0, K) is the integer part for a finite positive integer K. In case 1 (typical terrestrial scenario), I=0 and the Rel-17 UE RX-TX time difference measurement report can be used. In case 3 (typical NTN scenario), I>0 and the Rel-17 UE RX-TX time difference measurement report cannot be used to report the true UE RX-TX time difference value (which is needed to calculate the true RTT). As the TA values in NTN will typically be several ms (“Case 3”), UE RX-TX time difference measurement needs to be enhanced.

In some embodiments, an NTN UE reports additional information to the gNB and/or LMF to complement its UE RX-TX time difference measurement. Specifically, an NTN UE will report the fractional part of its actual UE RX-TX time difference measurement using the Rel-17 UE RX-TX time difference measurement report, and will additionally report the integer part of its actual UE RX-TX time difference to the gNB and/or LMF. The actual UE Rx-Tx time difference is equal to the fractional part F plus the integer part I. For example, if the measurement result is 7.6 ms, then the fractional part is-0.4 ms and the integer part is 8 ms; if the measurement results is 0.4 ms, then the fractional part is 0.4 ms and the integer part is 7 ms.

To report the true UE RX-TX time difference in NTN comprising the integer part I and the fractional part F,
a new parameter can be defined to report I which can be sent in a new measurement report separately from the existing Rel-17 UE RX-TX time difference measurement report which can be used to report F; and/or
a new UE RX-TX time difference measurement report can be defined for NTN which contains at least one new parameter to indicate I in addition to the existing Rel-17 UE RX-TX time difference measurement parameter which indicates F.
a new UE RX-TX time difference measurement report can be defined for NTN which contains at least one new parameter to indicate the true UE RX-TX time difference F+I, i.e., as an alternative to extending the reporting range of the existing UE Rx-Tx time difference measurement, a new parameter with a larger range is introduced specifically for NTN. Alternatively, the reporting range of the Rel-17 UE RX-TX time difference measurement is extended to account for the potentially large TA values in NTN.

Example: As the actual UE RX-TX time difference is expected to be positive in NTN, the integer part I of the UE RX-TX time difference can be indicated using an N-bit field, where the N-bit field can indicate up to 2N non-negative integer values and the unit will be ms. To indicate the fractional part F, an M-bit field can be defined to indicate up to 2M values. If the integer part I is obtained from the actual UE RX-TX time difference via rounding, then the fractional part F∈(−0.5,0.5). If the integer part I is obtained from the actual UE RX-TX time difference via an integer flooring operation, then the fractional part F∈(0,1). If the integer part I is obtained from the actual UE RX-TX time difference via an integer ceiling operation, then the fractional part F∈(−1,0).

In some embodiments, if an instance of the measured UE RX-TX time difference is reported to the LMF by a UE and/or gNB using more than one parameters or reports (e.g., as described in the above exemplary embodiment where fractional and integer parts are reported), the LMF may derive the actual UE RX-TX time difference by combining (e.g., adding and/or subtracting) the reported quantities. In the example illustrated in “case 3,” the actual UE RX-TX time difference is 2.3 ms. In one example, the UE will report the fractional part 0.3 ms using the existing Rel-17 UE RX-TX time difference measurement report, and the integer part 2 ms using a new parameter which can be signaled separately or using a new NTN-specific UE RX-TX time difference measurement report which contains both the fractional part and the integer part. The LMF will then add the reported quantities to derive the actual UE RX-TX time difference.

In some embodiments, the format of the UE RX-TX time difference measurement report is defined to be configurable and can be configured by the network. In some aspects, the reporting range of the UE RX-TX time difference measurement is defined to be configurable and can be configured by the network. For example, different measurement reports can be configured for NTN cell with earth-fixed beam and NTN cell with earth-moving beams. Another example is that a shorter measurement report range can be configured for LEO and MEO. In some aspects, one or more UE RX-TX time difference measurement report formats can be defined and tied to one or more NTN satellite scenarios in the specification. In some aspects, one or more reporting ranges for the UE RX-TX time difference measurement report are defined and tied to one or more NTN satellite scenarios in the specification. For example, a shorter reporting range for UE RX-TX time difference is defined for LEO scenario and a longer range for MEO scenario. Another example is where different measurement reports are defined for earth-fixed beam and earth-moving beams.

In some embodiments, methods for how to complement the currently supported means for a UE to report its UE RX-TX time difference to the LMF to make it cover also NTN scenarios with much longer propagation delays than in the terrestrial network scenarios the current reporting means have been designed for are described. One exemplary way to complement the UE's RX-TX time difference reporting capability is to include suitable extensions in the most relevant IEs in the communication protocol between the UE and the LMF, i.e. LTE Positioning Protocol (LPP), utilizing the extension possibilities built into these IEs. In some aspects, the most suitable such IEs are the NR-Multi-RTT-SignalMeasurementInformation-r16 IE and the therein included IEs, the ASN.1 definitions of which, for convenience and for reference, are included below (copied from 3GPP TS 37.355 version 17.3.0).

-- ASN1START
NR-Multi-RTT-SignalMeasurementInformation-r16 ::= SEQUENCE {

| | |
|---|---|
| nr-Multi-RTT-MeasList-r16 | NR-Multi-RTT-MeasList-r16, |
| nr-NTA-Offset-r16 | ENUMERATED { nTA1, nTA2, nTA3, nTA4, ... } |

```
  OPTIONAL,
  ...,
  [[
```

| | |
|---|---|
| nr-SRS-TxTEG-Set-r17 | SEQUENCE (SIZE(1..maxTxTEG-Sets-r17)) OF |
| | NR-SRS-TxTEG-Element-r17 |

OPTIONAL

-- Cond

```
Case2-3
  ]],
  [[
```

| | | |
|---|---|---|
| nr-UE-RxTEG-TimingErrorMargin-r17 | TEG-TimingErrorMargin-r17 | OPTIONAL,-- Cond |

TEGCase3

| | | |
|---|---|---|
| nr-UE-TxTEG-TimingErrorMargin-r17 | TEG-TimingErrorMargin-r17 | OPTIONAL,-- Cond |

TEGCase2-3

| | | |
|---|---|---|
| nr-UE-RxTxTEG-TimingErrorMargin-r17 | RxTxTEG-TimingErrorMargin-r17 | OPTIONAL -- Cond |

TEGCase1-2
]]
}
NR-Multi-RTT-MeasList-r16 ::= SEQUENCE (SIZE(1..nrMaxTRPs-r16)) OF NR-Multi-RTT-
MeasElement-r16
NR-Multi-RTT-MeasElement-r16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-r15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-UE-RxTxTimeDiff-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  },
```

| | |
|---|---|
| nr-AdditionalPathList-r16 | NR-AdditionalPathList-r16 |

OPTIONAL,

| | |
|---|---|
| nr-TimeStamp-r16 | NR-TimeStamp-r16, |
| nr-TimingQuality-r16 | NR-TimingQuality-r16, |
| nr-DL-PRS-RSRP-Result-r16 | INTEGER (0..126) |

```
  OPTIONAL,
  nr-Multi-RTT-AdditionalMeasurements-r16
```

NR-Multi-RTT-AdditionalMeasurements-r16

```
  OPTIONAL,
  ...,
  [[
```

| | |
|---|---|
| nr-UE-RxTx-TEG-Info-r17 | NR-UE-RxTx-TEG-Info-r17 |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-r17 | NR-AdditionalPathListExt-r17 |

```
  OPTIONAL,
  nr-Multi-RTT-AdditionalMeasurementsExt-r17
```

NR-Multi-RTT-AdditionalMeasurementsExt-r17

```
  OPTIONAL
  ]]
}
NR-Multi-RTT-AdditionalMeasurements-r16 ::= SEQUENCE (SIZE (1..3)) OF
```

NR-Multi-RTT-AdditionalMeasurementElement-r16

NR-Multi-RTT-AdditionalMeasurementsExt-r17 ::= SEQUENCE (SIZE (1..maxAddMeasRTT-r17)) OF

NR-Multi-RTT-AdditionalMeasurementElement-r16

NR-Multi-RTT-AdditionalMeasurementElement-r16 ::= SEQUENCE {

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-DL-PRS-RSRP-ResultDiff-r16 | INTEGER (0..61) |

OPTIONAL,

| | |
|---|---|
| nr-UE-RxTxTimeDiffAdditional-r16 | CHOICE { |
| k0-r16 | INTEGER (0..8191), |
| k1-r16 | INTEGER (0..4095), |
| k2-r16 | INTEGER (0..2047), |
| k3-r16 | INTEGER (0..1023), |
| k4-r16 | INTEGER (0..511), |
| k5-r16 | INTEGER (0..255), |

```
    ...
  },
```

| | |
|---|---|
| nr-TimingQuality-r16 | NR-TimingQuality-r16, |
| nr-AdditionalPathList-r16 | NR-AdditionalPathList-r16 |

OPTIONAL,

| | |
|---|---|
| nr-TimeStamp-r16 | NR-TimeStamp-r16, |

```
  ...,
  [[
```

| | | |
|---|---|---|
| nr-UE-RxTx-TEG-Info-r17 | NR-UE-RxTx-TEG-Info-r17 | OPTIONAL, |
| nr-DL-PRS-FirstPathRSRP-ResultDiff-r17 | INTEGER (0..61) | OPTIONAL, |
| nr-los-nlos-IndicatorPerResource-r17 | LOS-NLOS-Indicator-r17 | OPTIONAL, |
| nr-AdditionalPathListExt-r17 | NR-AdditionalPathListExt-r17 | OPTIONAL |

]]
}
NR-SRS-TxTEG-Element-r17 ::= SEQUENCE {

| | | |
|---|---|---|
| nr-TimeStamp-r17 | NR-TimeStamp-r16 | OPTIONAL, |

-- Need OP

| nr-UE-Tx-TEG-ID-r17 | INTEGER (0..maxNumOfTxTEGs-1-r17), | |
|---|---|---|
| carrierFreq-r17 | SEQUENCE { | |
| | absoluteFrequencyPointA-r17 | ARFCN-ValueNR- |

r15,

| | |
|---|---|
| offsetToPointA-r17 | INTEGER |

(0..2199)

| | |
|---|---|
| } | OPTIONAL, |

| | |
|---|---|
| srs-PosResourceList-r17 | SEQUENCE (SIZE (1..maxNumOfSRS-PosResources-r17)) OF |
| | INTEGER (0..maxNumOfSRS-PosResources-1-r17), |

...
}

| NR-UE-RxTx-TEG-Info-r17 ::= | CHOICE { | |
|---|---|---|
| case1-r17 | SEQUENCE { | |
| | nr-UE-RxTx-TEG-ID-r17 | INTEGER |

(0..maxNumOfRxTxTEGs-1-r17)

| | }, | |
|---|---|---|
| case2-r17 | SEQUENCE { | |
| | nr-UE-RxTx-TEG-ID-r17 | INTEGER |

(0..maxNumOfRxTxTEGs-1-r17),

| | |
|---|---|
| nr-UE-Tx-TEG-Index-r17 | INTEGER (1..maxTxTEG-Sets- |

r17)

| | }, | |
|---|---|---|
| case3-r17 | SEQUENCE { | |
| | nr-UE-Rx-TEG-ID-r17 | INTEGER (0..maxNumOfRxTEGs |

1-r17),

| | |
|---|---|
| nr-UE-Tx-TEG-Index-r17 | INTEGER (1..maxTxTEG-Sets- |

r17)

],

...
}
-- ASN1STOP

Below follows a set of examples of how these IEs can be extended with new fields or CHOICE options, to enable UE RX-TX time difference reporting adapted to the long propagation delays in NTN. All examples are based on ASN.1 code from 3GPP TS 37.355 version 17.3.0, with the added extensions underlined and highlighted.

### Example 1

| nr-UE-RxTxTimeDiff-r16 | CHOICE { |
|---|---|
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |
| ..., | |
| [[ | |
| k6-r18 | INTEGER (0..985039), |

```
    k7-118 INTEGER (0. 3940155),
    k8-118 INTEGER (0. 31521239),
    ]]
  },
```

For the new CHOICE option parameters k6-r18, k7-r18 and k8-r18 above, the reporting quantity is a range in units of 32 T_{c}, just like k5-r16, and the range is large enough to cover the actual UE RX-TX time difference for three different maximum satellite altitudes.

### Example 2

NR-Multi-RTT-MeasElement-16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-r15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-UE-RxTxTimeDiff-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  },
```

| | |
|---|---|
| nr-AdditionalPathList-r16 | NR-AdditionalPathList-r16 |

OPTIONAL,

| | |
|---|---|
| nr-TimeStamp-r16 | NR-TimeStamp-r16, |
| nr-TimingQuality-r16 | NR-TimingQuality-r16, |
| nr-DL-PRS-RSRP-Result-r16 | INTEGER (0..126) |

```
  OPTIONAL,
  nr-Multi-RTT-AdditionalMeasurements-r16
```

NR-Multi-RTT-AdditionalMeasurements-r16

```
  OPTIONAL,
  ...,
  [[
```

| | |
|---|---|
| nr-UE-RxTx-TEG-Info-r17 | NR-UE-RxTx-TEG-Info-r17 |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-r17 | NR-AdditionalPathListExt-r17 |

```
  OPTIONAL,
  nr-Multi-RTT-AdditionalMeasurementsExt-r17
```

NR-Multi-RTT-AdditionalMeasurementsExt-r17

```
  OPTIONAL
  ]],
  [[
  nr-UE-RxTxTimeDiffIntegerPart-r18 INTEGER (1..512) OPTIONAL -- Unit: 1 ms
  ]]
}
```

The new nr-UE-RxTxTimeDiffIntegerPart-r18 field above provides the integer part of the reported measure, expressed in milliseconds. Combined with the fractional part in the nr-UE-RxTxTimeDiff-r16 field, it provides the actual UE RX-TX time difference (as previously described).

### Example 3

NR-Multi-RTT-MeasElement-r16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-r15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-UE-RxTxTimeDiff-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
      ...
  },
```

| | |
|---|---|
| nr-AdditionalPathList-r16 | NR-AdditionalPathList-r16 |

OPTIONAL,

| | |
|---|---|
| nr-TimeStamp-r16 | NR-TimeStamp-r16, |
| nr-TimingQuality-r16 | NR-TimingQuality-r16, |
| nr-DL-PRS-RSRP-Result-r16 | INTEGER (0..126) |

```
  OPTIONAL,
  nr-Multi-RTT-AdditionalMeasurements-r16
```

NR-Multi-RTT-AdditionalMeasurements-r16

```
  OPTIONAL,
  ...,
  [[
```

| | |
|---|---|
| nr-UE-RxTx-TEG-Info-r17 | NR-UE-RxTx-TEG-Info-r17 |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-r17 | NR-AdditionalPathListExt-r17 |

```
  OPTIONAL,
  nr-Multi-RTT-AdditionalMeasurementsExt-r17
```

NR-Multi-RTT-AdditionalMeasurementsExt-r17

```
  OPTIONAL
  ]],
  [[
```

| | |
|---|---|
| ntn-UE-RxTxTimeDiff-r18 | CHOICE { |

k6-r18 INTEGER (0..985039),

| | |
|---|---|
| k7-r18 | INTEGER (0..3940155), |
| k8-r18 | INTEGER (0..31521239) |

```
  } OPTIONAL
  ]]
}
```

The choice alternatives k6-r18, k7-r18 and k8-r18 in the new ntn-UE-RxTxTimeDiff-r18 IE above, the reporting quantity is a range in units of 32 T_{c}, and the range is large enough to cover the actual UE RX-TX time difference for three different maximum satellite altitudes. When the ntn-UE-RxTxTimeDiff-r18 IE is present, it takes precedence over the nr-UE-RxTxTimeDiff-r16 IE, i.e. the receiver (the LMF) ignores the nr-UE-RxTxTimeDiff-r16 IE.

### Example 4

NR-Multi-RTT-MeasElement-r16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-r15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-UE-RxTxTimeDiff-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |

```
  ▴k5-r16 INTEGER (0..61565),
    ...
  },
```

| | |
|---|---|
| nr-AdditionalPathList-r16 | NR-AdditionalPathList-r16 |

OPTIONAL,

| | |
|---|---|
| nr-TimeStamp-r16 | NR-TimeStamp-r16, |
| nr-TimingQuality-r16 | NR-TimingQuality-r16, |
| nr-DL-PRS-RSRP-Result-r16 | INTEGER (0..126) |

```
  OPTIONAL,
  nr-Multi-RTT-AdditionalMeasurements-r16
```

NR-Multi-RTT-AdditionalMeasurements-r16

```
  OPTIONAL,
  ...,
  [[
```

| | |
|---|---|
| nr-UE-RxTx-TEG-Info-r17 | NR-UE-RxTx-TEG-Info-r17 |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-r17 | NR-AdditionalPathListExt-r17 |

```
  OPTIONAL,
  nr-Multi-RTT-AdditionalMeasurementsExt-r17
```

NR-Multi-RTT-AdditionalMeasurementsExt-r17

```
  OPTIONAL
  ]],
  [[
  ntn-UE-RxTxTimeDiff-r18 INTEGER (0..31521239) OPTIONAL
  ]]
}
```

The new ntn-UE-RxTxTimeDiff-r18 IE above expresses the actual UE RX-TX time difference in units of 32 T_{c}. When the ntn-UE-RxTxTimeDiff-r18 IE is present, it takes precedence over the nr-UE-RxTxTimeDiff-r16 IE, i.e. the receiver (the LMF) ignores the nr-UE-RxTxTimeDiff-r16 IE.

An additional piece of information that may be useful to report from the UE to the LMF is a timestamp of each measurement, which is provided in a format that the LMF can use to calculate the satellite position based on the ephemeris data associated with the satellite. This may be suitable in solution options where the LMF is provided with the ephemeris data, e.g. from an OAM node, a satellite control center or the gNB. The reporting possibilities in LPP already provides the possibility to include a timestamp expressed in SFN and slot numbers (in the NR-TimeStamp-r16 IE in the NR-Multi-RTT-MeasElement-r16 IE), but there may be scenarios where the LMF cannot unambiguously translate a timestamp of that format into an actual time, such a UTC timestamp, which can be used to calculate the satellite position based on the ephemeris data.

In some aspects, one exemplary way to extend LPP to allow a UE to report a timestamp of a format suitable for satellite position calculation is to use the prepared extension possibility in the NR-TimeStamp-r16 IE in LPP. The following is an ASN.1 example of such an extension, where the selected timestamp format is UTC. The ASN.1 example is based on ASN.1 code from 3GPP TS 37.355 version 17.3.0, with the added extension underlined and highlighted.

-- ASN1START
NR-TimeStamp-r16 ::= SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARECN-ValueNR-r15 | OPTIONAL, -- Need ON |

| | |
|---|---|
| nr-SEN-r16 | INTEGER (0..1023), |
| nr-Slot-r16 | CHOICE { |
| scs15-r16 | INTEGER (0..9), |
| scs30-116 | INTEGER (0..19), |
| scs60-r16 | INTEGER (0..39), |
| scs120-r16 | INTEGER (0..79) |

```
  },
  ...,
  [[
```

| | |
|---|---|
| timeStampUTC-r18 | INTEGER (0..549755813887) -- Unit: 10 ms |

]]
}
-- ASN1STOP

In the above example, the granularity in the UTC timestamp is 10 ms (i.e. the unit is 10 ms). Another option, which provides greater accuracy in the satellite position calculation may be to make the unit 1 ms and consequently increase the range by a factor 10.

In some aspects, another exemplary way to extend LPP to allow a UE to report a timestamp of a format suitable for satellite position calculation is to use the prepared extension possibility in the NR-TimeStamp-r16 IE in LPP. The following is an example of such an extension, where the new field is a UTC timestamp. The ASN.1 example is based on ASN.1 code from 3GPP TS 37.355 version 17.3.0, with the added extension underlined and highlighted.

NR-Multi-RTT-MeasElement-r16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-E15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-UE-RxTxTimeDiff-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  },
```

| | |
|---|---|
| nr-AdditionalPathList-r16 | NR-AdditionalPathList-r16 |

OPTIONAL,

| | |
|---|---|
| nr-TimeStamp-r16 | NR-TimeStamp-r16, |
| nr-TimingQuality-r16 | NR-TimingQuality-r16, |
| nr-DL-PRS-RSRP-Result-r16 | INTEGER (0..126) |

```
  OPTIONAL,
  nr-Multi-RTT-AdditionalMeasurements-r16
```

NR-Multi-RTT-AdditionalMeasurements-r16

```
  OPTIONAL,
  ...,
  [[
```

| | |
|---|---|
| nr-UE-RxTx-TEG-Info-r17 | NR-UE-RxTx-TEG-Info-r17 |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-x17 | NR-AdditionalPathListExt-r17 |

```
  OPTIONAL,
  nr-Multi-RTT-AdditionalMeasurementsExt-r17
```

NR-Multi-RTT-AdditionalMeasurementsExt-r17

```
  OPTIONAL
  ]],
  [[
  timeStampUTC-r18 INTEGER (0..5497558138870) -- Unit: 1 ms
  ]]
}]
```

In the above example, the granularity in the UTC timestamp is 1 ms (i.e. the unit is 1 ms). Another option would be to make the unit 10 ms and the range (0 . . . 549755813887).

In some embodiments, the UE reports its TA and the Common TA to the network (i.e. gNB and/or LMF) as already proposed in the disclosure included in the Appendix of the US provisional application to which the present disclosure claims priority. Instead of reporting the UE-RX time difference, the UE reports the difference D between the sum of the TA and Common TA and the UE-RX time difference, i.e.:

D=UE-RX time difference−(TA+Common TA)

Similar to other exemplary embodiments based on integer and fractional part reporting, the method of this exemplary embodiment supports a compact reporting format using a fine resolution in the reporting of D.

The network can based on received TA, Common TA and difference D, compute the UE-RX TX time difference, i.e.:

UE-RX TX time difference=D+(TA+Common TA)

### gNB RX-TX Time Difference in NTN

Ideally, the time difference measured at the gNB should be compensated by the feeder link RTT to produce the relevant measure at the satellite, so that the LMF can use the multiple RTT measurements to calculated multiple distances between the satellite and the UE, from different satellite positions, and from this calculate the UE's location Alternatively, the gNB sends the feeder link delay to the LMF together with the RX-TX time difference report.

### Assistance Information Related Embodiments

With reference to the disclosure included in the Appendix below, some NTN-specific assistance information sent from UE to LMF and/or gNB were proposed including:

For example: one or more of the following NTN-specific assistance information is sent from gNB to LMF for network verified UE location:
UL time synchronization reference point for NTN
Feeder link delay or RTT
Koffset
Kmac
Common TA, TA drift parameters
UE reported location and/or TA
Ephemeris

In addition, one or more of the following can also be sent in addition to the NTN-specific assistance information already mentioned in the disclosure included in the Appendix below:
Satellite ID (e.g., to help identify the satellite for which the UE/gNB perform RX-TX time difference measurements
The satellite position at each RTT measurement

In some embodiments, one or more of the following NTN-specific assistance information is sent from LMF to the UE for network verified UE location:
Satellite ID
Time until the satellite will be available
Time until the NTN cell will be available.
Whether to use the existing Rel-17 UE RX-TX time difference measurement report or a new NTN-specific UE RX-TX time difference measurement report.

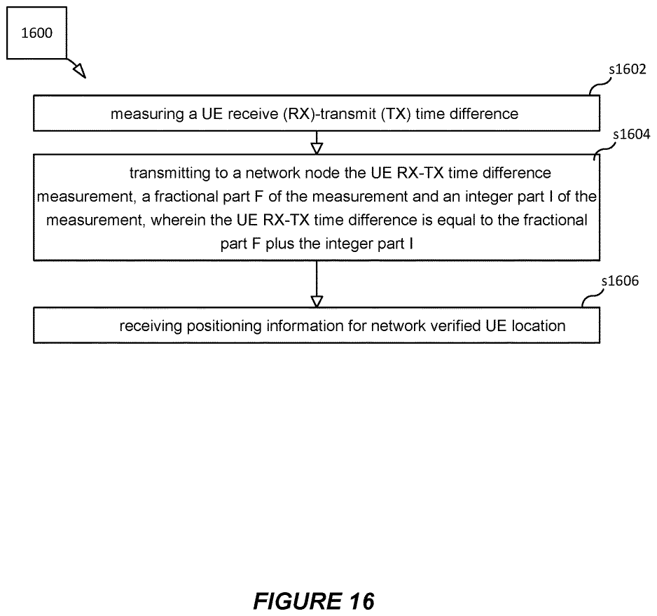

FIG. 16 is a flowchart illustrating a process 1600 according to some embodiments. Process 1600 may be performed by a UE for supporting a network verified UE location in a non-terrestrial network (NTN). Process 1600 may begin in step s1602.

Step s1602 comprises measuring a UE receive (RX)-transmit (TX) time difference.

Step s1604 comprises transmitting to a network node the UE RX-TX time difference measurement, a fractional part F of the measurement and an integer part I of the measurement. The UE RX-TX time difference is equal to the fractional part F plus the integer part I.

Step s1606 comprises optionally receiving positioning information for network verified UE location.

In some embodiments, process 1600 comprises transmitting to the network node timestamp information for the UE RX-TX time difference measurement.

In some embodiments, the received positioning information includes one or more of: (i) satellite ID; (ii) time until a satellite will be available; (iii) time until a NTN cell will be available; or (iv) whether to use a existing Rel-17 UE RX-TX time difference measurement report or a new NTN-specific UE RX-TX time difference measurement report.

In some embodiments, process 1600 comprises transmitting to the network node NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, process 1600 comprises transmitting to the network node information including one or more of: (i) satellite identification (ID); or (ii) position information for a satellite at each round trip time (RTT) measurement.

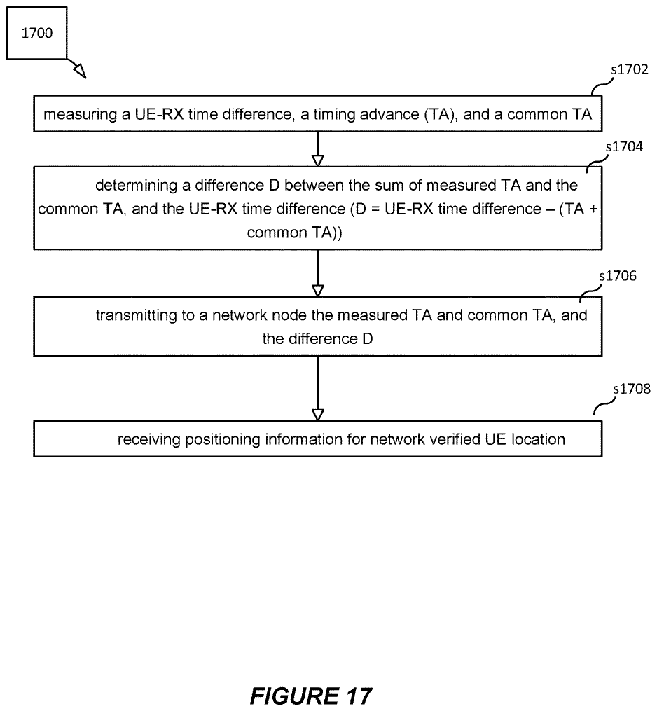

FIG. 17 is a flowchart illustrating a process 1700 according to some embodiments. Process 1700 may be performed by a UE for supporting a network verified UE location in a non-terrestrial network (NTN). Process 1700 may begin in step s1702.

Step s1702 comprises measuring a UE-RX time difference, a timing advance (TA), and a common TA.

Step s1704 comprises determining a difference D between the sum of measured TA and the common TA, and the UE-RX time difference (D-UE-RX time difference−(TA+common TA)).

Step s1706 comprises transmitting to a network node the measured TA and common TA, and the difference D.

Step s1708 comprises receiving positioning information for network verified UE location.

In some embodiments, the received positioning information includes one or more of: (i) satellite ID; (ii) time until a satellite will be available; (iii) time until a NTN cell will be available; or (iv) whether to use a existing Rel-17 UE RX-TX time difference measurement report or a new NTN-specific UE RX-TX time difference measurement report.

In some embodiments, process 1700 comprises transmitting to the network node NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, process 1700 comprises transmitting to the network node information including one or more of: (i) satellite identification (ID); or (ii) position information for a satellite at each round trip time (RTT) measurement.

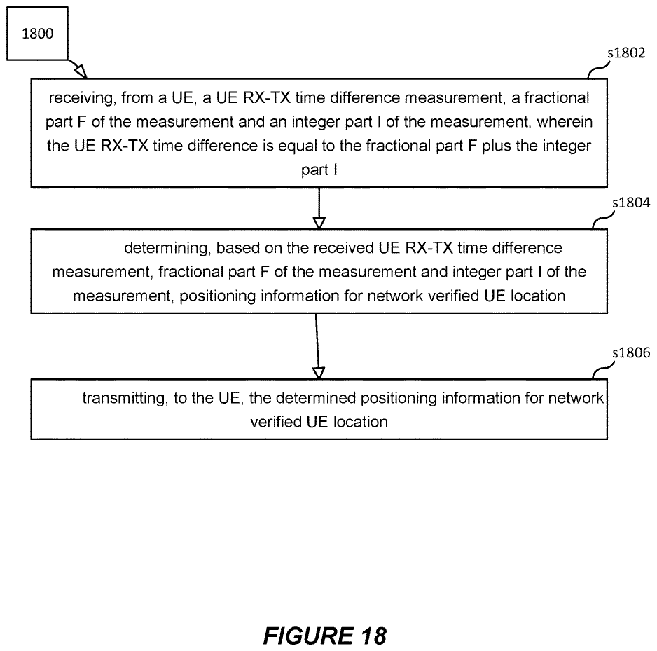

FIG. 18 is a flowchart illustrating a process 1800 according to some embodiments. Process 1800 may be performed by a network node for supporting a network verified user equipment (UE) location in a non-terrestrial network (NTN). Process 1800 may begin in step s1802.

Step s1802 comprises receiving, from a UE, a UE RX-TX time difference measurement, a fractional part F of the measurement and an integer part I of the measurement. The UE RX-TX time difference is equal to the fractional part F plus the integer part I.

Step s1804 comprises determining, based on the received UE RX-TX time difference measurement, fractional part F of the measurement and integer part I of the measurement, positioning information for network verified UE location.

Step s1806 comprises transmitting, to the UE, the determined positioning information for network verified UE location.

In some embodiments, process 1800 comprises receiving, from the UE, a network node timestamp information for the UE RX-TX time difference measurement.

In some embodiments, the transmitted positioning information includes one or more of: (i) satellite ID; (ii) time until the satellite will be available; (iii) time until the NTN cell will be available; and (iv) whether to use the existing Rel-17 UE RX-TX time difference measurement report or a new NTN-specific UE RX-TX time difference measurement report.

In some embodiments, process 1800 comprises receiving from the UE NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, process 1800 comprises receiving from the UE information including one or more of: (i) satellite identification (ID); or (ii) position information for a satellite at each round trip time (RTT) measurement.

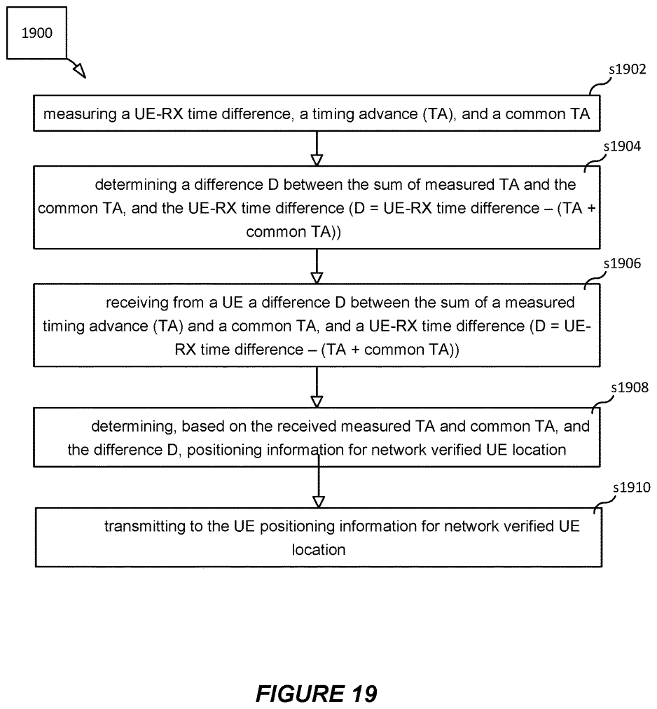

FIG. 19 is a flowchart illustrating a process 1900 according to some embodiments. Process 1900 may be performed by a network node for supporting a network verified user equipment (UE) location in a non-terrestrial network (NTN). Process 1900 may begin in step s1902.

Step s1902 comprises measuring a UE-RX time difference, a timing advance (TA), and a common TA.

Step s1904 comprises determining a difference D between the sum of measured TA and the common TA, and the UE-RX time difference (D=UE-RX time difference−(TA+common TA)).

Step s1906 comprises receiving from a UE a difference D between the sum of a measured timing advance (TA) and a common TA, and a UE-RX time difference (D=UE-RX time difference−(TA+common TA)).

Step s1908 comprises determining, based on the received measured TA and common TA, and the difference D, positioning information for network verified UE location.

Step s1910 comprises transmitting to the UE positioning information for network verified UE location.

In some embodiments, the transmitted positioning information includes one or more of: (i) satellite ID; (ii) time until a satellite will be available; (iii) time until a NTN cell will be available; or (iv) whether to use a existing Rel-17 UE RX-TX time difference measurement report or a new NTN-specific UE RX-TX time difference measurement report.

In some embodiments, process 1900 comprises receiving from the UE NTN-specific assistance information including one or more of: (i) a uplink (UL) time synchronization reference point for NTN; (ii) a feeder link delay; (iii) round trip time (RTT); (iv) Koffset; (v) Kmac; (vi) common timing advance (TA); (vii) TA drift parameters; (vii) UE reported location; (viii) UE reported TA; or (viii) ephemeris information.

In some embodiments, process 1900 comprises receiving from the UE information including one or more of: (i) satellite identification (ID); or (ii) position information for a satellite at each round trip time (RTT) measurement.

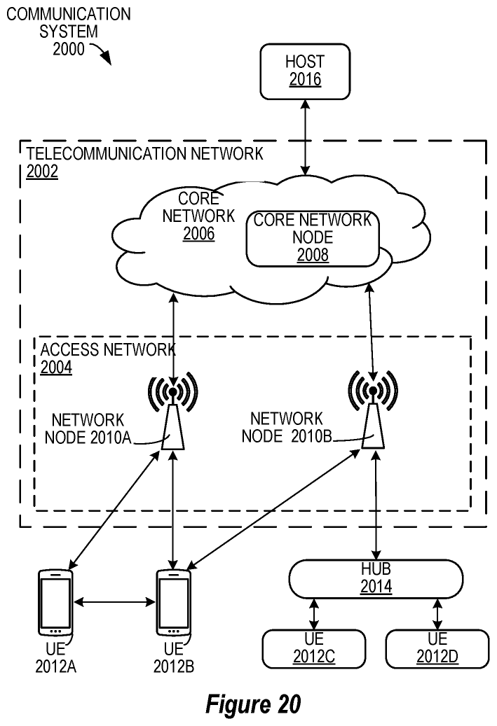

FIG. 20 shows an example of a communication system 2000 in accordance with some embodiments.

In the example, the communication system 2000 includes a telecommunication network 2002 that includes an access network 2004, such as a radio access network (RAN), and a core network 2006, which includes one or more core network nodes 2008. The access network 2004 includes one or more access network nodes, such as network nodes 2010a and 2010b (one or more of which may be generally referred to as network nodes 2010), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 2002 includes one or more Open-RAN (ORAN) network nodes. An ORAN network node is a node in the telecommunication network 2002 that supports an ORAN specification (e.g., a specification published by the O-RAN Alliance, or any similar organization) and may operate alone or together with other nodes to implement one or more functionalities of any node in the telecommunication network 2002, including one or more network nodes 2010 and/or core network nodes 2008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 2010 facilitate direct or indirect connection of user equipment (UE), such as by connecting UEs 2012a, 2012b, 2012c, and 2012d (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2002 is a cellular network that implements 3GPP standardized features. Accordingly, the telecommunications network 2002 may support network slicing to provide different logical networks to different devices that are connected to the telecommunication network 2002. For example, the telecommunications network 2002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2014 communicates with the access network 2004 to facilitate indirect communication between one or more UEs (e.g., UE 2012c and/or 2012d) and network nodes (e.g., network node 2010b). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a VR headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular if one or more of the UEs are low energy IoT devices.

The hub 2014 may have a constant/persistent or intermittent connection to the network node 2010b. The hub 2014 may also allow for a different communication scheme and/or schedule between the hub 2014 and UEs (e.g., UE 2012c and/or 2012d), and between the hub 2014 and the core network 2006. In other examples, the hub 2014 is connected to the core network 2006 and/or one or more UEs via a wired connection. Moreover, the hub 2014 may be configured to connect to an M2M service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010b. In other embodiments, the hub 2014 may be a non-dedicated hub—that is, a device which is capable of operating to route communications between the UEs and network node 2010b, but which is additionally capable of operating as a communication start and/or end point for certain data channels.

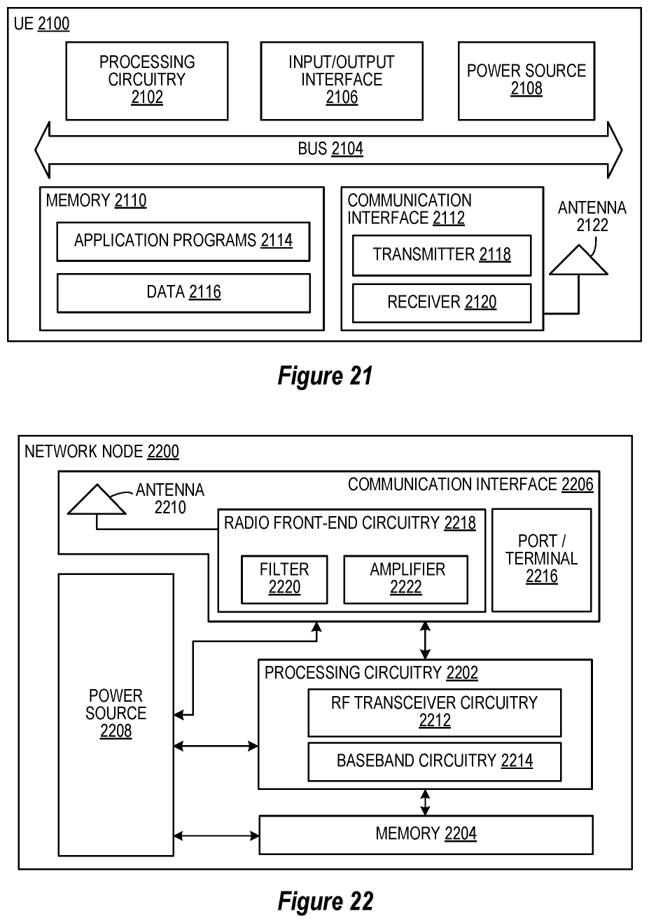

FIG. 21 shows a UE 2100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2100 includes processing circuitry 2102 that is operatively coupled via a bus 2104 to an input/output interface 2106, a power source 2108, a memory 2110, a communication interface 2112, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2102 may include multiple central processing units (CPUs).

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging of the power source 2108. Power circuitry may perform any formatting, converting, or other modification to the power from the power source 2108 to make the power suitable for the respective components of the UE 2100 to which power is supplied.

The memory 2110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2110 may allow the UE 2100 to access instructions, application programs and the like, stored on transitory or non-transitory memory media, to off-load data, or to upload data. An article of manufacture, such as one utilizing a communication system may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., antenna 2122) and may share circuit components, software or firmware, or alternatively be implemented separately.

In the illustrated embodiment, communication functions of the communication interface 2112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node 2200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes a processing circuitry 2202, a memory 2204, a communication interface 2206, and a power source 2208. The network node 2200 may be composed of multiple physically separate components (e.g., a NodeB component and a RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2200 may be configured to support multiple radio access technologies (RATs). In such embodiments, some components may be duplicated (e.g., separate memory 2204 for different RATs) and some components may be reused (e.g., a same antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2200.

The processing circuitry 2202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2200 components, such as the memory 2204, to provide network node 2200 functionality.

In some embodiments, the processing circuitry 2202 includes a system on a chip (SOC). In some embodiments, the processing circuitry 2202 includes one or more of radio frequency (RF) transceiver circuitry 2212 and baseband processing circuitry 2214. In some embodiments, the radio frequency (RF) transceiver circuitry 2212 and the baseband processing circuitry 2214 may be on separate chips (or sets of chips), boards, or units, such as radio units and digital units. In alternative embodiments, part or all of RF transceiver circuitry 2212 and baseband processing circuitry 2214 may be on the same chip or set of chips, boards, or units.

The memory 2204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and memory 2204 is integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. Radio front-end circuitry 2218 comprises filters 2220 and amplifiers 2222. The radio front-end circuitry 2218 may be connected to an antenna 2210 and processing circuitry 2202. The radio front-end circuitry may be configured to condition signals communicated between antenna 2210 and processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of filters 2220 and/or amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface may comprise different components and/or different combinations of components.

In certain alternative embodiments, the network node 2200 does not include separate radio front-end circuitry 2218, instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes one or more ports or terminals 2216, the radio front-end circuitry 2218, and the RF transceiver circuitry 2212, as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, communication interface 2206, and/or the processing circuitry 2202 may be configured to perform any receiving operations and/or certain obtaining operations described herein as being performed by the network node. Any information, data and/or signals may be received from a UE, another network node and/or any other network equipment. Similarly, the antenna 2210, the communication interface 2206, and/or the processing circuitry 2202 may be configured to perform any transmitting operations described herein as being performed by the network node. Any information, data and/or signals may be transmitted to a UE, another network node and/or any other network equipment.

The power source 2208 provides power to the various components of network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid, an electricity outlet) via an input circuitry or interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 22 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

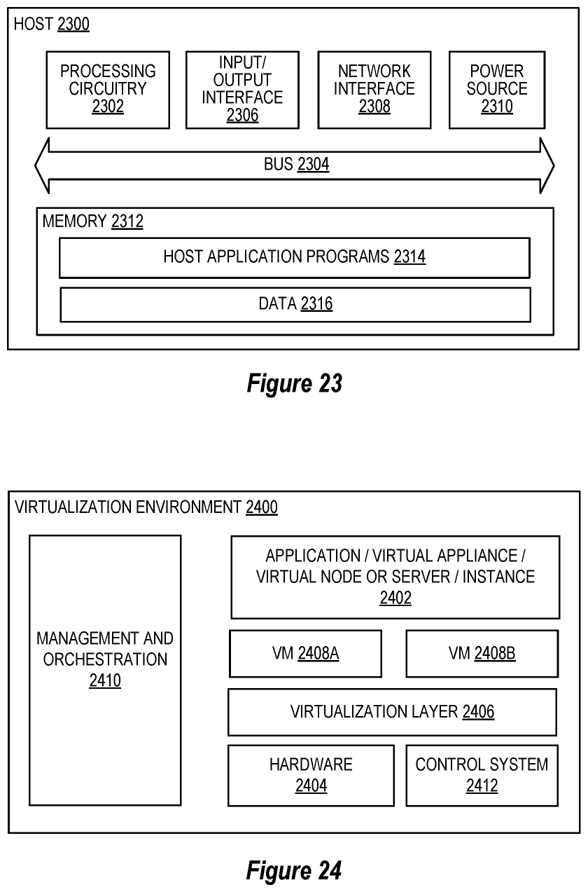

FIG. 23 is a block diagram of a host 2300, which may be an embodiment of the host 2016 of FIG. 20, in accordance with various aspects described herein. As used herein, the host 2300 may be or comprise various combinations hardware and/or software, including a standalone server, a blade server, a cloud-implemented server, a distributed server, a virtual machine, container, or processing resources in a server farm. The host 2300 may provide one or more services to one or more UEs.

The host 2300 includes processing circuitry 2302 that is operatively coupled via a bus 2304 to an input/output interface 2306, a network interface 2308, a power source 2310, and a memory 2312. Other components may be included in other embodiments. Features of these components may be substantially similar to those described with respect to the devices of previous figures, such as FIGS. 21 and 22, such that the descriptions thereof are generally applicable to the corresponding components of host 2300.

The memory 2312 may include one or more computer programs including one or more host application programs 2314 and data 2316, which may include user data, e.g., data generated by a UE for the host 2300 or data generated by the host 2300 for a UE. Embodiments of the host 2300 may utilize only a subset or all of the components shown. The host application programs 2314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2314 may also provide for user authentication and licensing checks and may periodically report health, routes, and content availability to a central node, such as a device in or on the edge of a core network. Accordingly, the host 2300 may select and/or indicate a different host for over-the-top services for a UE. The host application programs 2314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment 2400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2400 includes components defined by the O-RAN Alliance, such as an O-Cloud environment orchestrated by a Service Management and Orchestration Framework via an O-2 interface.

Applications 2402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or virtual machine monitors (VMMs)), provide VMs 2408a and 2408b (one or more of which may be generally referred to as VMs 2408), and/or perform any of the functions, features and/or benefits described in relation with some embodiments described herein. The virtualization layer 2406 may present a virtual operating platform that appears like networking hardware to the VMs 2408.

The VMs 2408 comprise virtual processing, virtual memory, virtual networking or interface and virtual storage, and may be run by a corresponding virtualization layer 2406. Different embodiments of the instance of a virtual appliance 2402 may be implemented on one or more of VMs 2408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2408 may be a software implementation of a physical machine that runs programs as if they were executing on a physical, non-virtualized machine. Each of the VMs 2408, and that part of hardware 2404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2408 on top of the hardware 2404 and corresponds to the application 2402.

Hardware 2404 may be implemented in a standalone network node with generic or specific components. Hardware 2404 may implement some functions via virtualization. Alternatively, hardware 2404 may be part of a larger cluster of hardware (e.g. such as in a data center or CPE) where many hardware nodes work together and are managed via management and orchestration 2410, which, among others, oversees lifecycle management of applications 2402. In some embodiments, hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2412 which may alternatively be used for communication between hardware nodes and radio units.

One or more of the various embodiments improve the performance of OTT services provided to the UE using an OTT connection, in which the wireless connection forms the last segment. More precisely, the teachings of these embodiments may improve the provision of accurate positioning information for the UE—i.e., network verified UE location in NTN, for example with a multi-RTT based method in NTN.

As explained previously, NTN has the advantages of service continuity, scalability and availability, which will support 3GPP, 5G systems to achieve their challenging use cases, such as enhanced mobile broadband (eMBB), ultra-reliable and low latency communication (URLLC), NB-IoT and mMTC. 5G includes the New Radio (NR) access stratum interface and the 5G Core Network (5GC). The NR physical and higher layers are reusing parts of the LTE specification, and to that add needed components when motivated by new use cases.

To benefit from the strong mobile ecosystem and economy of scale, the satellite network based on the terrestrial wireless access technologies including LTE and NR for satellite networks, is being specified in the 3GPP standard Service continuity means that the network can provide connection to UE at anytime and anywhere. Service scalability means that the network can maintain good service despite an increase in traffic load because of the support of NTN. Service availability means that the network is always available even in cases of disasters or similar situations. However, to facilitate these functionalities, the NTN needs to know the UE position. The teachings of the embodiments described herein may improve the provision of accurate positioning information for the UE—i.e., network verified UE location in NTN, for example with a multi-RTT based method in NTN, and thereby provide benefits such as, trustworthiness of UE reporting, ensuring that the trustworthiness of location verification cannot be compromised, improved service continuity, service scalability and service availability.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLES

### Group A Examples

Example A1. A method performed by a user equipment (UE) for supporting a network verified UE location in a non-terrestrial network (NTN), the method comprising:
measuring a UE RX-TX time difference;
transmitting to a network node the UE RX-TX time difference measurement, a fractional part F of the measurement and an integer part I of the measurement, wherein the UE RX-TX time difference is equal to the fractional part F plus the integer part I; and
receiving positioning information for network verified UE location.

Example A2. The method of the previous example, further comprising:
transmitting to the network node timestamp information for the UE RX-TX time difference measurement.

Example A3. The method of any of the previous examples, wherein the received positioning information includes one or more of:
(i) satellite ID;
(ii) time until the satellite will be available;
(iii) time until the NTN cell will be available; and
(iv) whether to use the existing Rel-17 UE RX-TX time difference measurement report or a new NTN-specific UE RX-TX time difference measurement report.

Example A4. The method of any of the previous examples, further comprising transmitting to the network node NTN-specific assistance information including one or more of:
(i) UL time synchronization reference point for NTN;
(ii) Feeder link delay or RTT;
(iii) Koffset;
(iv) Kmac;
(v) Common TA, TA drift parameters;
(vi) UE reported location and/or TA; and
(vii) Ephemeris.

Example A5. The method of any of the previous examples, further comprising transmitting to the network node information including one or more of:
(i) Satellite ID; and
(ii) position information for a satellite at each RTT measurement.

### Group B Examples

Example B1. A method performed by a user equipment (UE) for supporting a network verified UE location in a non-terrestrial network (NTN), the method comprising:
measuring a UE-RX time difference, a timing advance (TA), and a common TA;
determining a difference D between the sum of measured TA and the common TA, and the UE-RX time difference (D=UE-RX time difference−(TA+common TA);
transmitting to a network node the measured TA and common TA, and the difference D; and
receiving positioning information for network verified UE location.

Example B2. The method of any of the previous examples, wherein the received positioning information includes one or more of:
(i) satellite ID;
(ii) time until the satellite will be available;
(iii) time until the NTN cell will be available; and
(iv) whether to use the existing Rel-17 UE RX-TX time difference measurement report or a new NTN-specific UE RX-TX time difference measurement report.

Example B3. The method of any of the previous examples, further comprising transmitting to the network node NTN-specific assistance information including one or more of:
(i) UL time synchronization reference point for NTN;
(ii) Feeder link delay or RTT;
(iii) Koffset;
(iv) Kmac;
(v) Common TA, TA drift parameters;
(vi) UE reported location and/or TA; and
(vii) Ephemeris.

Example B4. The method of any of the previous examples, further comprising transmitting to the network node information including one or more of:
(i) Satellite ID; and
(ii) position information for a satellite at each RTT measurement.

### Group C Examples

Example C1. A method performed by a network node for supporting a network verified user equipment (UE) location in a non-terrestrial network (NTN), the method comprising:
receiving, from a UE, a UE RX-TX time difference measurement, a fractional part F of the measurement and an integer part I of the measurement, wherein the UE RX-TX time difference is equal to the fractional part F plus the integer part I;
determining, based on the received UE RX-TX time difference measurement, fractional part F of the measurement and integer part I of the measurement, positioning information for network verified UE location; and
transmitting, to the UE, the determined positioning information for network verified UE location.

Example C2. The method of the previous example, further comprising:
receiving, from the UE, a network node timestamp information for the UE RX-TX time difference measurement.

Example C3. The method of any of the previous examples, wherein the transmitted positioning information includes one or more of:
(i) satellite ID;
(ii) time until the satellite will be available;
(iii) time until the NTN cell will be available; and
(iv) whether to use the existing Rel-17 UE RX-TX time difference measurement report or a new NTN-specific UE RX-TX time difference measurement report.

Example C4. The method of any of the previous examples, further comprising receiving from the UE NTN-specific assistance information including one or more of:
(i) UL time synchronization reference point for NTN;
(ii) Feeder link delay or RTT;
(iii) Koffset;
(iv) Kmac;
(v) Common TA, TA drift parameters;
(vi) UE reported location and/or TA; and
(vii) Ephemeris.

Example C5. The method of any of the previous examples, further comprising receiving from the UE information including one or more of:
(i) Satellite ID; and
(ii) position information for a satellite at each RTT measurement.

### Group D Examples

Example D1. A method performed by a network node for supporting a network verified user equipment (UE) location in a non-terrestrial network (NTN), the method comprising:
measuring a UE-RX time difference, a timing advance (TA), and a common TA;
determining a difference D between the sum of measured TA and the common TA, and the UE-RX time difference (D=UE-RX time difference−(TA+common TA);
receiving from a UE a difference D between the sum of a measured timing advance (TA) and a common TA, and a UE-RX time difference (D=UE-RX time difference−(TA+common TA);
determining, based on the received measured TA and common TA, and the difference D, positioning information for network verified UE location; and
transmitting to the UE positioning information for network verified UE location.

Example D2. The method of the previous example, wherein the transmitted positioning information includes one or more of:
(i) satellite ID;
(ii) time until the satellite will be available;
(iii) time until the NTN cell will be available; and
(iv) whether to use the existing Rel-17 UE RX-TX time difference measurement report or a new NTN-specific UE RX-TX time difference measurement report.

Example D3. The method of any of the previous examples, further comprising receiving from the UE NTN-specific assistance information including one or more of:
(i) UL time synchronization reference point for NTN;
(ii) Feeder link delay or RTT;
(iii) Koffset;
(iv) Kmac;
(v) Common TA, TA drift parameters;
(vi) UE reported location and/or TA; and
(vii) Ephemeris.

Example D4. The method of any of the previous examples, further comprising receiving from the UE information including one or more of:
(i) Satellite ID; and
(ii) position information for a satellite at each RTT measurement.

### Group E Examples

Example E1. A user equipment for supporting a network verified user equipment (UE) location in a non-terrestrial network (NTN), comprising:
processing circuitry configured to perform any of the steps of any of the Group A examples; and
power supply circuitry configured to supply power to the processing circuitry.

Example E2. A user equipment for supporting a network verified user equipment (UE) location in a non-terrestrial network (NTN), comprising:
processing circuitry configured to perform any of the steps of any of the Group B examples; and
power supply circuitry configured to supply power to the processing circuitry.

Example E3. A network node for supporting a network verified user equipment (UE) location in a non-terrestrial network (NTN), the network node comprising:
processing circuitry configured to perform any of the steps of any of the Group C examples;
power supply circuitry configured to supply power to the processing circuitry.

Example E4. A network node for supporting a network verified user equipment (UE) location in a non-terrestrial network (NTN), the network node comprising:
processing circuitry configured to perform any of the steps of any of the Group D examples;
power supply circuitry configured to supply power to the processing circuitry.

Example E5. A user equipment (UE) for supporting a network verified user equipment (UE) location in a non-terrestrial network (NTN), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A examples;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Example E6. A user equipment (UE) for supporting a network verified user equipment (UE) location in a non-terrestrial network (NTN), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group B examples;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

The following represents an example standards discussion paper related to one or more embodiments disclosed herein.

In the revised NR Rel-18 WID on NTN enhancement, the objective on network verified UE location is defined as follows:
Based on RAN1 conclusions of the study phase, RAN to prioritize the specification of necessary enhancements to multi-RTT to support the network verified UE location in NTN assuming a single satellite in view [RAN1, 2, 3, 4].
DL-TDoA methods for verification may be considered as lower priority and if time permits and condition in Note is satisfied.
Note 1: Enhancements assume reuse of the RAT dependent positioning framework
Note 2: The specification of DL-TDOA enhancements will be subject to the study of the impact of realistic UE clock drift onto DL-TDOA performance
Note 3: The target accuracy for position verification purposes is as documented in clause «recommendations» of the 3GPP TR 38.882 (i.e. 10 km granularity)
Note 4: Multiple satellite in view by the UE may be considered if time allows
Note 5: The enhancements may be subject to relevant SA WGs (e.g. SA3/SA3-LI) feedbacks on the reliability of UE reports involved
Note 6: The enhancements should take into account the mirror-image ambiguity Note 7: Network verified UE location is an optional UE feature

In light of the above objective, we share our preliminary views on enhancing the existing specification to support network verification of UE location in NR NTN.

### 1 MULTI-RTT ENHANCEMENTS FOR NTN

In multi-RTT positioning, both the UE and the gNB measure and report their respective RX-TX time differences to the LMF. The UE RX-TX time difference can be measured using the DL-PRS or CSI-RS while the gNB RX-TX time difference can be measured using UL-SRS. In TS 38.215, the UE and gNB RX-TX time difference measurements are defined as follows:
“The UE Rx-Tx time difference is defined as T_{UE-RX}−T_{UE-TX}
Where:
T_{UE-RX} is the UE received timing of downlink subframe #i from a Transmission Point (TP) [18], defined by the first detected path in time.
T_{UE-TX} is the UE transmit timing of uplink subframe #j that is closest in time to the subframe #i received from the TP.”

We note that the transmit time in the above definition is the UE transmit timing of the uplink subframe #j that is closest in time to the downlink subframe #i, and not necessarily the transmit timing of the UL SRS.
“The gNB Rx-Tx time difference is defined as T_{gNB-RX}−T_{gNB-TX}
Where:
T_{gNB-RX} is the Transmission and Reception Point (TRP) received timing of uplink subframe #i containing SRS associated with UE, defined by the first detected path in time.
T_{gNB-TX} is the TRP transmit timing of downlink subframe #j that is closest in time to the subframe #i received from the UE.”

The above definitions show that there is no coupling required between DL-PRS and UL-SRS for multi-RTT positioning as the RX-TX time difference measurements at the UE and the gNB can be performed independently of each other.

According to TS 38.133, the reporting range of UE Rx-Tx time difference is ~−0.5 ms to +0.5 ms:

“The reporting range for the absolute UE Rx-Tx time difference measurement (TUE Rx-Tx) is defined from −985024′T_{c} to 985024′T_{c} with the resolution step of 2^{k}′T_{c}[ . . . ]”

These definitions have been crafted for terrestrial networks where the timing advance (TA) value is typically much smaller than 1 ms. As the TA in an NTN can be several ms, the existing specification needs to be enhanced to enable multi-RTT based positioning for UE location verification in NTN. We illustrate the shortcomings of the existing UE RX-TX time difference definition via three examples:

### Case 1: Small TA (TA<0.5 ms)

When the TA is small (TA<0.5 ms), j=i in the UE Rx-Tx time difference definition above. In this case, UE Rx-Tx time difference is equal to the TA. This is illustrated as below. The RTT can be calculated as RTT=(UE Rx-Tx time difference)+ (gNB Rx-Tx time difference). For ease of illustration, the following figures depict the UL subframe #i being used for gNB RX-TX time difference measurement. Please note that this is not required by the specification.

This is depicted in FIG. 13.

Case 2: Moderate TA (0.5 ms<TA<1 ms)

When 0.5 ms<TA<1 ms, uplink subframe j=i+1 is closer to downlink subframe i. In this case, UE Rx-Tx time difference is negative and equal to (TA−1 ms). This case is illustrated below. The RTT can be calculated as RTT-(UE Rx-Tx time difference)+(gNB Rx-Tx time difference)+(1 ms).

This is depicted in FIG. 14.

### Case 3: Large TA (TA>1 ms)

When TA>1 ms, as will be typically the case in NTN, the existing UE RX-TX time difference measurement will lead to erroneous calculation of RTT. As an example, consider the below illustration where the TA is ~2.3 ms, j=i+2, UE Rx-Tx time difference=(TA−2 ms) and RTT=(UE Rx-Tx time difference)+ (gNB Rx-Tx time difference)+ (2 ms).

This is depicted in FIG. 15.

As evident from cases 2 and 3, the UE will not end up measuring the intended RX-TX time difference in NTN scenarios if the Rel-17 definition is followed. Therefore, the definition can be modified in NTN as follows:
“The UE Rx-Tx time difference in an NTN cell is defined as T_{UE-RX}−T_{UE-TX}
Where:
T_{UE-RX} is the UE received timing of downlink subframe #i from a Transmission Point (TP), defined by the first detected path in time.
T_{UE-TX} is the UE transmit timing of uplink subframe #j that is closest in time to the subframe #i received from the TP #i.”

Therefore, we propose the following:

RAN1 to modify the definition of the UE RX-TX time difference measurement for NTN.

The true UE RX-TX time difference measurement TUE in NTN can be expressed as T_{UE}=T_{UE,F}+T_{UE,1}, where T_{UE,F}∈(−0.5, 0.5) is the fractional part and T_{UE,1}∈(0, K) is the integer part for a finite positive integer K. In case 1 (typical terrestrial scenario), T_{UE,I}=0 and the Rel-17 UE RX-TX time difference measurement report can be used. In case 3 (typical NTN scenario), T_{UE,I}>0 and the Rel-17 UE RX-TX time difference measurement report cannot be used to report the true UE RX-TX time difference value (which is needed to calculate the true RTT). Therefore, we make the following observations.

The Rel-17 UE RX-TX time difference measurement report is not sufficient to allow sufficiently accurate RTT calculation in NTN.

Although an NTN UE needs to report its true UE RX-TX time difference value to the LMF, it can merely report its fractional part if it were to use the Rel-17 UE RX-TX time difference measurement report given its limited reporting range of +/−0.5 ms.

As the TA values in NTN will typically be several ms (“Case 3”), UE RX-TX time difference measurement definition and the measurement report need to be enhanced for NTN. Specifically, the UE will need to calculate and report its true UE RX-TX time difference in NTN.

UE to report its true UE RX-TX time difference measurement value to the LMF using one of the following options:

Option 1: Extend the range of the UE RX-TX time difference measurement report for NTN.

Option 2: Define a new measurement parameter in NTN to enable the UE to report the integer part of its true RX-TX time difference measurement, and reuse the Rel-17 UE RX-TX time difference measurement parameter to report the fractional part of its true RX-TX time difference measurement.

Previously, RAN1 has identified the need to address mirror image ambiguity in NTN. This is clearly reflected in the following note in the WID:
“Note 6: The enhancements should take into account the mirror-image ambiguity”

The Rel-17 specification optionally supports using UL-AoA measurements at the gNB in conjunction with the UE/gNB RX-TX time difference measurements to improve the performance of multi-RTT positioning. UL-AoA can be used for resolving the mirror image ambiguity for UE location verification in NTN. Additionally, SA2 has requested to complete location verification within a preferred period of 30 s and a maximum period of 1 min. UL-AoA measurements can also help reduce the verification latency for UEs located sufficiently away from a regional or country border. Therefore, RAN1 should also enhance UL-AoA for NTN.

RAN1 to support and enhance the optional Rel-17 UL-AoA measurements defined for multi-RTT positioning to help resolve mirror image ambiguity and reduce UE location verification latency in NTN.

### 2 TRUSTWORTHINESS OF UE REPORTING

In the revised WID, the following ensures that the trustworthiness of location verification cannot be compromised.

“Note 5: The enhancements may be subject to relevant SA WGs (e.g. SA3/SA3-LI) feedbacks on the reliability of UE reports involved”

Let us consider the TA reported by the UE. Even though the UE reports an incorrect UE location, it must still use the true UE location for calculating the TA and frequency pre-compensation values. Otherwise, the NTN UE cannot possibly communicate with the gNB (transmissions arriving at the gNB will be well outside the cyclic prefix and/or non-aligned with the intended frequency). Thus, a fake reported UE location means that the 3GPP chipset is already handling two UE locations, and it would be very simple for the UE to report a fake TA corresponding to the reported fake UE position. Therefore, we argue that the reported TA cannot be considered “independent from the location information reported by the UE” as stated in the TR recommendations.

UE reporting of TA cannot be trusted for the purpose of network-verified UE location in NTN.

### 3 CONCLUSION

Based on the discussion in the previous sections we made the following observations:

Observation 1 The Rel-17 UE RX-TX time difference measurement report is not sufficient to allow sufficiently accurate RTT calculation in NTN.

Observation 2 Although an NTN UE needs to report its true UE RX-TX time difference value to the LMF, it can merely report its fractional part if it were to use the Rel-17 UE RX-TX time difference measurement report given its limited reporting range of +/−0.5 ms.

Based on the discussion in the previous sections we propose the following:

Proposal 1 RAN1 to modify the definition of the UE RX-TX time difference measurement for NTN.

Proposal 2 UE to report its true UE RX-TX time difference measurement value to the LMF using one of the following options:

Option 1: Extend the range of the UE RX-TX time difference measurement report for NTN.

Option 2: Define a new measurement parameter in NTN to enable the UE to report the integer part of its true RX-TX time difference measurement, and reuse the Rel-17 UE RX-TX time difference measurement parameter to report the fractional part of its true RX-TX time difference measurement.

Proposal 3 RAN1 to support and enhance the optional Rel-17 UL-AoA measurements defined for multi-RTT positioning to help resolve mirror image ambiguity and reduce UE location verification latency in NTN.

Proposal 4 UE reporting of TA cannot be trusted for the purpose of network-verified UE location in NTN.

1-7. (canceled)

8. A method performed by a user equipment (UE) for supporting a network verified UE location in a non-terrestrial network (NTN), the method comprising:
measuring a UE-RX time difference, a timing advance (TA), and a common TA;
determining a difference D between the sum of measured TA and the common TA, and the UE-RX time difference (D=UE-RX time difference−(TA+common TA));
transmitting to a network node the measured TA and common TA, and the difference D; and
receiving positioning information for network verified UE location.

9. The method according to claim 8, wherein the received positioning information includes one or more of:
(i) satellite ID;
(ii) time until a satellite will be available;
(iii) time until a NTN cell will be available; or
(iv) whether to use a existing Rel-17 UE RX-TX time difference measurement report or a new NTN-specific UE RX-TX time difference measurement report.

10. The method according to claim 8, further comprising transmitting to the network node NTN-specific assistance information including one or more of:
(i) a uplink (UL) time synchronization reference point for NTN;
(ii) a feeder link delay;
(iii) round trip time (RTT);
(iv) Koffset;
(v) Kmac;
(vi) common timing advance (TA);
(vii) TA drift parameters;
(vii) UE reported location;
(viii) UE reported TA; or
(viii) ephemeris information.

11. The method according to claim 8, further comprising transmitting to the network node information including one or more of:
(i) satellite identification (ID); or
(ii) position information for a satellite at each round trip time (RTT) measurement.

12. A user equipment (UE) for supporting a network verified user equipment location in a non-terrestrial network (NTN), the UE comprising processing circuitry, the processing circuitry being configured to cause the UE to:
measure a UE-RX time difference, a timing advance (TA), and a common TA;
determine a difference D between the sum of measured TA and the common TA, and the UE-RX time difference (D=UE-RX time difference−(TA+common TA));
transmit to a network node the measured TA and common TA, and the difference D; and
receive positioning information for network verified UE location.

13. A user equipment (UE) for supporting a network verified user equipment location in a non-terrestrial network (NTN), the UE comprising processing circuitry, the processing circuitry being configured to cause the UE to perform the method of claim 8.

14-20. (canceled)

21. A method performed by a network node for supporting a network verified user equipment (UE) location in a non-terrestrial network (NTN), the method comprising:
measuring a UE-RX time difference, a timing advance (TA), and a common TA;
determining a difference D between the sum of measured TA and the common TA, and the UE-RX time difference (D=UE-RX time difference−(TA+common TA));
receiving from a UE a difference D between the sum of a measured timing advance (TA) and a common TA, and a UE-RX time difference (D=UE-RX time difference−(TA+common TA));
determining, based on the received measured TA and common TA, and the difference D, positioning information for network verified UE location; and
transmitting to the UE positioning information for network verified UE location.

22. The method according to claim 21, wherein the transmitted positioning information includes one or more of:
(i) satellite ID;
(ii) time until a satellite will be available;
(iii) time until a NTN cell will be available; or
(iv) whether to use a existing Rel-17 UE RX-TX time difference measurement report or a new NTN-specific UE RX-TX time difference measurement report.

23. The method according to claim 21, further comprising receiving from the UE NTN-specific assistance information including one or more of:
(i) a uplink (UL) time synchronization reference point for NTN;
(ii) a feeder link delay;
(iii) round trip time (RTT);
(iv) Koffset;
(v) Kmac;
(vi) common timing advance (TA);
(vii) TA drift parameters;
(vii) UE reported location;
(viii) UE reported TA; or
(viii) ephemeris information.

24. The method according to claim 21, further comprising receiving from the UE information including one or more of:
(i) satellite identification (ID); or
(ii) position information for a satellite at each round trip time (RTT) measurement.

25. A network node for supporting a network verified user equipment (UE) location in a non-terrestrial network (NTN), the network node comprising processing circuitry, the processing circuitry being configured to cause the network node to:
measure a UE-RX time difference, a timing advance (TA), and a common TA;
determine a difference D between the sum of measured TA and the common TA, and the UE-RX time difference (D=UE-RX time difference−(TA+common TA));
receive from a UE a difference D between the sum of a measured timing advance (TA) and a common TA, and a UE-RX time difference (D=UE-RX time difference−(TA+common TA));
determine, based on the received measured TA and common TA, and the difference D, positioning information for network verified UE location; and
transmit to the UE positioning information for network verified UE location.

26-27. (canceled)

28. A computer program product comprising a non-transitory computer readable medium storing a computer program for supporting a network verified user equipment (UE) location in a non-terrestrial network (NTN), the computer program comprising computer code which, when run on processing circuitry of the UE, causes the UE to:
measure a UE-RX time difference, a timing advance (TA), and a common TA;
determine a difference D between the sum of measured TA and the common TA, and the UE-RX time difference (D=UE-RX time difference−(TA+common TA));
transmit to a network node the measured TA and common TA, and the difference D; and
receive positioning information for network verified UE location.

29. (canceled)

30. A computer program product comprising a non-transitory computer readable medium storing a computer program for supporting a network verified user equipment (UE) location in a non-terrestrial network (NTN), the computer program comprising computer code which, when run on processing circuitry of a network node, causes the network node to:
measure a UE-RX time difference, a timing advance (TA), and a common TA;
determine a difference D between the sum of measured TA and the common TA, and the UE-RX time difference (D=UE-RX time difference−(TA+common TA));
receive from a UE a difference D between the sum of a measured timing advance (TA) and a common TA, and a UE-RX time difference (D=UE-RX time difference−(TA+common TA));
determine, based on the received measured TA and common TA, and the difference D, positioning information for network verified UE location; and
transmit to the UE positioning information for network verified UE location.
